(19) United States
(12) Patent Application Publication
(10) Pub. No.: US 2022/0050048 A1
(43) Pub. Date: Feb. 17, 2022

(54) MICROPLATE READER

(71) Applicants: Ushio Denki Kabushiki Kaisha, Tokyo (JP); KYUSHU UNIVERSITY, NATIONAL UNIVERSITY CORPORATION, Fukuoka-shi, Fukuoka (JP)

(72) Inventors: Kinichi MORITA, Tokyo (JP); Shinji SUZUKI, Tokyo (JP); Yuji OKI, Fukuoka-shi (JP)

(73) Assignee: KYUSHU UNIVERSITY, NATIONAL UNIVERSITY CORPORATION, Fukuoka-shi, Fukuoka (JP)

(21) Appl. No.: 17/274,545

(22) PCT Filed: Sep. 5, 2019
(86) PCT No.: PCT/JP2019/034910

§ 371 Date: Mar. 9, 2021

(30) Foreign Application Priority Data
Sep. 11, 2018 (JP) 2018-169740

(51) Int. Cl. G01N 21/03; G01N 21/59

(52) U.S. Cl. CPC G01N 21/03; G01N 21/59

(57) ABSTRACT

A microplate reader includes a plurality of sets of: a light emitting portion disposed on one side of a microplate and corresponding to one well of the microplate; a light receiving portion disposed on an opposite side to the light emitting portion across the microplate and corresponding to one well of the microplate; and a light receiving light guide path disposed between the light receiving portion and the microplate and guiding light emitted from the light emitting portion and passing through a sample contained in the well to the light receiving portion. The microplate reader further includes a light guiding section configured to enclose a plurality of the light receiving light guide paths by an enclosure member made of a pigment-containing resin containing a pigment having a light-absorbing property. Light emitted from one light emitting portion passing through one light receiving light guide path and reaching one light receiving portion.

### TECHNICAL FIELD

The present invention relates to a microplate reader that performs an optical measurement of samples contained in wells of a microplate.

### BACKGROUND ART

Conventionally, flat microplates made of, for example, acrylic, polyethylene, polystyrene, glass, or the like, with a large number of depressions (i.e., wells) have been used for separation, synthesis, extraction, analysis, and cell culture and the like of reagents. For example, a certain measurement (e.g., measurement by Enzyme-Linked Immuno Sorbent Assay (ELISA) method) relating to antibody antigen reaction (enzyme immunoreaction), which is generated by injecting a reagent containing antigens into each well to which an antibody is fixed, are performed using a microplate.

For example, the optical properties of the sample contained in each well of the microplate are measured. This measurement is performed by a microplate reader, which is a measurement device that performs the optical measurement of the above sample. The microplate reader is capable of measuring optical properties such as, for example, absorbance, fluorescence, chemiluminescence, and fluorescence polarization, and the like.

As an exemplary conventional microplate reader, for example, there is a technology described in Patent Literature 1 (Laid-open Publication of Japanese Patent Application No. 2014-41121 A1). The microplate reader described in the Patent Literature 1 (Laid-open Publication of Japanese Patent Application No. 2014-41121 A1) has an optical measurement/detection device (measurement head) for performing light irradiation on a sample and performing an optical measurement by observing the light emission from the light-irradiated sample. Light irradiation from the measurement head to the microplate is performed from beneath each well of the microplate, and the measurement head measures the observed light emitted upward from each well.

The measurement head is fixed, and the microplate is scanned in two-dimensional directions (X and Y directions) by the driving mechanism of the microplate reader such that the wells are positioned on the detection axis of the measurement head (i.e., the axis vertical to the microplate (2 axis)).

In addition, Patent Literature 2 (Laid-open Publication of Japanese Patent Application No. 2009-103480 A1) discloses a microplate reader that is downsized enough to be portable. The microplate reader described in the Patent Literature 2 (Laid-open Publication of Japanese Patent Application No. 2009-103480 A1) has a space in which a series of eight microplates with eight wells being arranged in a row can be inserted, and the microplates is slidable in the space. The microplate reader is configured to irradiate the sample held in the wells with light from the upper part of the above space and from the position facing the upper surface of the wells of the microplate. Further, in the lower part of the above space, there is provided a photodiode that detects the light emitted from the sample. The microplate reader performs the optical measurement while sliding the microplate in the above space.

### LISTING OF REFERENCES

### Patent Literature

PATENT LITERATURE 1: Laid-open Publication of Japanese Patent Application No. 2014-41121 A1

PATENT LITERATURE 2: Laid-open Publication of Japanese Patent Application No. 2009-103480 A1

### SUMMARY OF THE INVENTION

### Problems to be Solved by the Invention

However, the microplate reader described in the Patent Literature 1 (Laid-open Publication of Japanese Patent Application No. 2014-41121 A1) necessarily requires a driving mechanism to scan the microplate each time for each optical measurement, making the microplate reader device itself a larger scale.

For this reason, it is difficult to cope with the demand for miniaturized devices in fields such as point-of-care testing (POCT) in the life sciences field.

In addition, although the microplate reader described in the Patent Literature 2 (Laid-open Publication of Japanese Patent Application No. 2009-103430 A1) is miniaturized enough to be portable, external light is likely to be incident as noise light to a space into which the microplate is inserted. Therefore, it makes it difficult to perform the optical measurement of a sample contained in respective wells with high accuracy.

Taking the above mentioned circumstances into consideration, the present invention has been made in order to solve the above mentioned problems and an object thereof is to provide a microplate reader that is capable of being miniaturized and performing optical measurements of all the samples contained in all wells of the microplate with higher accuracy.

### Solution to Problems

In order to solve the above-mentioned problems, according to one aspect of a microplate reader of the present invention, there is provided a microplate reader comprising: a housing; a light emitting portion disposed on one side of a microplate having a plurality of wells in the housing and configured to correspond to one well of the microplate; a light receiving portion disposed on an opposite side to the light emitting portion across the microplate and configured to correspond to one well of the microplate; a light receiving light guide path disposed between the light receiving portion and the microplate and configured to guide light emitted from the light emitting portion and passing through a sample contained in the well to the light receiving portion; and a light guiding section configured to enclose a plurality of the light receiving light guide paths by an enclosure member made of a pigment-containing resin containing a pigment having a light-absorbing property, and a plurality of sets of the light emitting portion, the light receiving portion, and the light receiving light guide path being provided corresponding to one well of the microplate, and light emitted from one light emitting portion passing through one light receiving light guide path and reaching one light receiving portion.

Thus, the light emitting portion, the light receiving portion, and the light receiving light guide path are provided corresponding to one well, and a plurality of sets of the light emitting portions, the light receiving portions, and the light receiving light guide paths are provided. Further, the microplate reader is provided with the light guiding section configured to enclose a plurality of light receiving light guide paths by the pigment-containing resin capable of absorbing external light or scattered light. Therefore, it makes it possible to suppress the external light or the scattered light from entering the light receiving portion as stray light (i.e., noise light). This eliminates the need for a complicated optical system to deal with multiple stray light scattering or the like, so as to reduce the size of the optical system.

In addition, since it makes it possible to prevent light emitted from a plurality of light emitting portions from passing through one light receiving light guide path and reaching one light receiving portion, measurement error can be appropriately reduced. As a result, measurements with higher accuracy are obtainable.

In the microplate reader described above, a number of sets of the light emitting portion, the light receiving portion, and the light receiving light guide path corresponding to one well may be at least as many as a number of the wells in the microplate.

In this case, the optical measurement of all the samples contained in all wells of the microplate can be performed almost simultaneously, thus shortening the measurement, time. In addition, since there is no need for a complicated driving mechanism or the like for scanning the microplate as in the prior art, the size of the microplate reader can be reduced.

Furthermore, in the microplate reader described above, a number of sets of the light emitting portion, the light receiving portion, and the light receiving light guide path corresponding to one well may be less than a number of the wells, and the microplate reader may further comprise a moving mechanism configured to sequentially move the microplate relative to the set of the light emitting portion, the light receiving portion, and the light receiving light guide path so as to correspond to all wells of the microplate.

In this case, there is no need to provide a set of the light emitting portion, the light receiving portion, and the light receiving light guide path for all wells of the microplate, thus, it makes it possible to reduce the size of the microplate reader significantly. In addition, by sequentially moving the microplate relative to the set of the light emitting portion, the light receiving portion, and the light receiving light guide path, it makes it possible to perform the optical measurement of all of the samples contained in all wells of the microplate.

Yet furthermore, in the microplate reader described above, a number of sets of the light emitting portion, the light receiving portion, and the light receiving light guide path corresponding to one well may be as many as a number of wells on one side of the microplate, and the moving mechanism sequentially may move the microplate relative to the set of the light emitting portion, the light receiving portion, and the light receiving light guide portion solely in a direction orthogonal to the one side.

In this case, the movement by the moving mechanism can be a movement in only one axis direction. Therefore, the structure of the moving mechanism can be simplified, and it can be fabricated inexpensively. In addition, since it can be made thinner, it makes it possible to install the microplate reader in a limited space, such as a culture space in an incubator.

Yet furthermore, in the microplate reader described above, where o denotes a point where a light emitting surface on which light emitters of a plurality of the light emitting portions are disposed and an optical axis of the light receiving light guide path intersect, La denotes a distance from the light emitting surface to an end face of the light receiving light guide path on the light receiving portion side. Lb denotes an optical path length of the light receiving light guide path, and d denotes a width of the light receiving light guide path, the light emitting portion may be arranged such that only one light emitter of the light emitting portion lies in a circular region of a radius r defined by a following equation with the point o at a center on the light emitting surface:

r=d(La/Lb−1/2)

In this way, the position at which the light emitting portion is arranged may be defined based on the shape of the light receiving light guide path for guiding light from the microplate to the light receiving portion. In this case, only one light emitting portion that emits light that may directly reach the light receiving portion without being absorbed by the pigment-containing resin enclosing the light receiving light guide path can be provided for one light receiving portion. In other words, it makes it possible to prevent light from other adjacent light emitting portions from directly reaching the light receiving portion as external light without being absorbed by the pigment-containing resin enclosing the light receiving light guide path. Therefore, the measurement error can be appropriately reduced.

Yet furthermore, the microplate reader described above may further comprise a limiting member configured to limit light emitted from the light emitting portion adjacent to the one light emitting portion from entering the one light receiving light guide path corresponding to the one light emitting portion.

Thus, by arranging the limiting member in this way, it makes it possible to ensure that there is only one light emitting portion that emits light reaching one light receiving portion. Therefore, the measurement error can be appropriately reduced.

Yet furthermore, in the microplate reader described above, the limiting member may be an aperture plate disposed on the light emitting portion side of the light guiding section and configured to have an aperture allowing light passing through the sample to enter the light receiving light guide path and being smaller than an aperture of a light incident end of the light receiving light guide path.

Thus, by arranging the aperture plate in this way, it makes it possible to limit the angular component of the light incident on the light receiving light guide path. In addition, in this case, it makes it possible to easily adjust the range of incidence of light into the light receiving light guide path by setting the size of the opening in the aperture plate as appropriate.

Yet furthermore, in the microplate reader described above, the limiting member may be a protruding portion provided on an inner wall of the light receiving light guide path and configured to limit a width of the light receiving light guide path.

Thus, by providing the protruding portion on the inner wall of the light receiving light guide path, it makes it possible to appropriately limit the light entering or exiting the light receiving light guide path. In this case, by setting the size of the protruding portion appropriately, the width of the light receiving light guide path can be easily adjusted.

Yet furthermore, in the microplate reader described above, the limiting member may be a shielding member disposed between the light emitting portions adjacent to each other.

Thus, by placing the shielding member between the light emitting portions, it makes it possible to prevent problems such that light emitted from one light emitting portion reaches the surface of an adjacent light emitting portion, is reflected, and enters the well corresponding to the adjacent light emitting portion.

Yet furthermore, in the microplate reader described above, the light guiding section may be disposed above the light receiving portion, and the light emitting portion may be disposed above the microplate disposed above the light guiding section.

Thus, the microplate reader may be structured to have the light guiding section disposed above the light receiving portion, the microplate disposed above the light guiding section, and the light emitting portion disposed above the microplate. In this case, the light receiving portion and the light guiding section may be fixed inside the housing, the microplate containing the sample may be placed on the light guiding section, and the upper part of the microplate may be covered by the light emitting portion. Therefore, the microplate reader can be made easy to set up.

Yet furthermore, in the microplate reader described above, the microplate reader may further comprise: a light emitting substrate having a power supply circuit to supply power to the plurality of light emitting portions and to which the light emitting portions are electrically connected; and a light receiving substrate having a power supply circuit to supply power to the plurality of light receiving portions and to which the light emitting portions are electrically connected.

In this case, the power supply to the plurality of light emitting portions can be realized by a single printed circuit board on which the wiring pattern is formed. Similarly, the power supply to the plurality of light receiving portions can be realized by a single printed circuit board on which the wiring pattern is formed. Therefore, the microplate reader can be made smaller.

Yet furthermore, in the microplate reader described above, the light emitting portion may be a light emitting diode. Since light emitting diodes (LEDs) are small, it makes it possible to install the light emitting portion one by one appropriately corresponding to each well. In addition, since LEDs are relatively inexpensive, the microplate reader can be realized at a low cost.

Yet furthermore, in the microplate reader described above, the light receiving portion may be a light receiving sensor. In this case, the light receiving portion can be a color sensor, so that measurement data can be easily obtained.

Yet furthermore, in the microplate reader described above, the light receiving portion may be an optical fiber. In this case, the light guided by a plurality of optical fibers can be captured by an image sensor, and the optical measurement data can be acquired as image data. In this case, the optical measurement data corresponding to all wells can be processed simultaneously in a batch.

Yet furthermore, in the microplate reader described above, at least a part of the light receiving light guide path may be filled with a resin having a light transmitting property, which constitutes the pigment-containing resin.

In this case, it makes it possible to suppress reflection and scattering of light at the interface between the light receiving light guide path and the enclosure member. Therefore, the measurement error caused by stray light can be suppressed more effectively.

Yet furthermore, in the microplate reader described above, the light receiving light guide path may be made of a resin having a light transmitting property and may consist of a flat part and a columnar member extending from the flat part in a columnar shape. It makes it possible to suppress the scattering of light incident from the flat part.

Also, in the microplate reader described above, a stepped portion may be provided at a connecting part between the flat part and the columnar member such that a diameter at the connecting part side is larger than a diameter at a front end of the columnar member.

With this configuration, it makes it possible to suppress the influence of the external light.

According to one aspect of a microplate reader unit of the present invention, there is provided a microplate reader unit comprising: a unit light source section having a light emitting portion corresponding to one well of a microplate; and a unit light guiding section including: a light receiving portion provided corresponding to one well of the microplate; a light receiving light guide path configured to guide light emitted from the light emitting portion and passing through a sample contained in a corresponding well to the light receiving portion; and an enclosure member configured to enclose the light receiving light guide path by a pigment-containing resin containing a pigment having a light absorbing property, and light that passes through the light receiving light guide path included in one unit light guiding section and reaches the light receiving portion is light emitted from the light emitting portion included one unit light source section.

It makes it possible to construct a microplate reader that can be miniaturized and can perform optical measurements of all the samples contained in respective wells of the microplate with higher accuracy.

Furthermore, in the microplate reader unit described above, the light receiving light guide path may be made of a resin having a light transmitting property and may consist of a flat part and a columnar member extending from the flat part in a columnar shape.

With this configuration, it makes it possible to suppress the scattering of light incident from the flat part.

Yet furthermore, in the microplate reader unit described above, a stepped portion may be provided at a connecting part between the flat part and the columnar member such that a diameter at the connecting part side is larger than a diameter at a front end of the columnar member.

With this configuration, it makes it possible to suppress the influence of the external light.

### ADVANTAGEOUS EFFECT OF THE INVENTION

According to various aspects of the microplate reader of the present invention, it makes it possible to miniaturize the microplate reader, and perform optical measurements of all the samples contained in all wells of the microplate with higher accuracy.

The objects, embodiments and effects of the present invention described above, as well as the objects, embodiments and effects of the invention not described above, will be understood by those skilled in the art from the following detailed description of the embodiments for implementing the invention by referring to the accompanying drawings and the appended claims.

### BRIEF DESCRIPTION OF DRAWINGS

FIG. 1 is a schematic diagram showing an exemplary configuration a microplate reader according to the present embodiment.

FIG. 2 is an exploded perspective view showing an exemplary main portion of the microplate reader.

FIG. 3 is a view showing an exemplary power supply line for a light source and a sensor.

FIG. 4 is a view illustrating external light entering a light guide path.

FIG. 5 is a view illustrating an exemplary light passage path.

FIG. 6 is a view illustrating the incidence of light (stray light) from adjacent light sources.

FIG. 7 is a view illustrating an exemplary arrangement position of the light source.

FIG. 8 is a view illustrating how to set up the microplate reader.

FIG. 9 is a view illustrating how to set up the microplate reader.

FIG. 10 is a view illustrating how to set up the microplate reader.

FIG. 11 is a view showing an exemplary configuration for batch processing of measurement data.

FIG. 12 is a view showing an exemplary configuration of the microplate reader unit.

FIG. 13 is a view showing an exemplary arrangement of the microplate reader unit.

FIG. 14 is a view showing another example of a microplate reader unit.

FIG. 15 is a view showing a measurement example in a 96-well microplate.

FIG. 16 is a view showing a measurement example in a 6-well microplate.

FIG. 17 is a view showing another exemplary microplate.

FIG. 18 is a view illustrating the influence of light emitted from adjacent light sources.

FIG. 19 is a schematic diagram showing another exemplary configuration of a microplate reader.

FIG. 20 is a schematic diagram showing yet another exemplary configuration of a microplate reader.

FIG. 21 is a view showing an aperture plate which is an example of a limiting member.

FIG. 22 is a view showing a protruding portion which is an example of the limiting member.

FIG. 23A is a view showing an exemplary manufacturing process of a light guide plate section.

FIG. 23B is a view showing an exemplary manufacturing process of the light guide plate section.

FIG. 23C .is a view showing an exemplary manufacturing process of the light guide plate section.

FIG. 23D is a view showing a defect in the light guide plate section.

FIG. 24A is a view showing another exemplary manufacturing process of the light guide plate section.

FIG. 24B is a view showing the light guide plate section consisting of a flat part and a columnar member.

FIG. 25A is a view showing another exemplary manufacturing process of the light guide plate section.

FIG. 25B is a view showing the light guide plate section with a stepped portion.

FIG. 26 is a view showing an exemplary scanning type microplate reader.

FIG. 27 is a view showing a main part of the scanning type microplate reader.

FIG. 28 is a view showing another exemplary scanning type microplate reader.

FIG. 29A is a view showing the position of the microplate during the first optical measurement.

FIG. 29B is a view showing the position of the microplate during the second optical measurement.

### DESCRIPTION OF EMBODIMENTS

Hereinafter, embodiments of the invention will be described with reference to the accompanying drawings in detail.

### First Embodiment

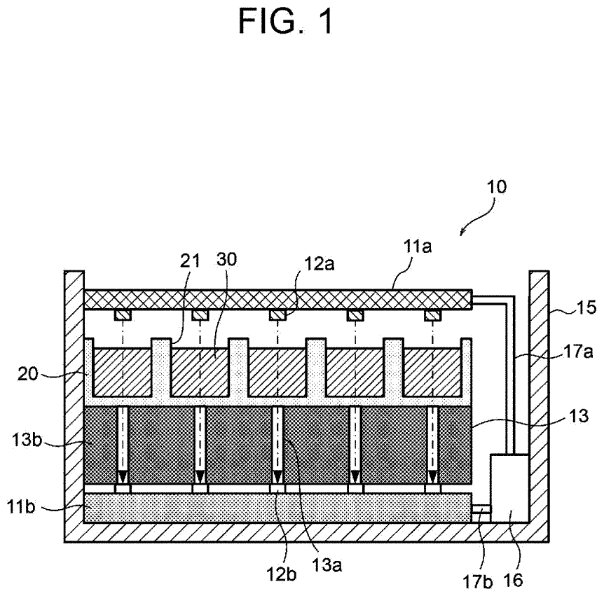

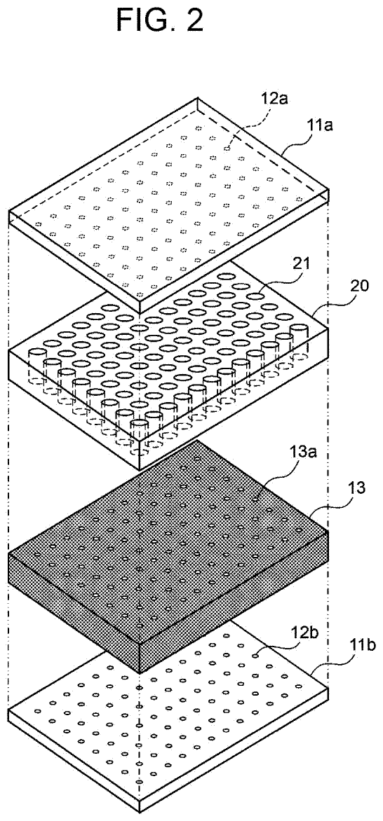

FIG. 1 is a schematic diagram showing an exemplary configuration of a microplate reader 10 according to the present embodiment. FIG. 2 is an exploded perspective view showing a main portion of the microplate reader 10.

The microplate reader 10 includes a light emitting substrate 11a, a measurement substrate 11b, a plurality of light sources (light emitting portions) 12a, a plurality of light receiving sensors (light receiving portions) 12b, a light guiding plate section (light guiding section) 13, a housing 15, a power supply unit 16, and power supply cables 17a and 17b.

The light emitting substrate 11a, the measurement substrate 11b, the plurality of light sources 12a, the plurality of light receiving sensors 12b, the light guide plate section 13, the power supply unit 16, and the power supply cables 17a and 17b are disposed and fixed in the housing 15 having an opening above. As shown in FIG. 2, the microplate reader 10 according to the present embodiment is configured such that the plurality of light receiving sensors 12b are provided on the measurement substrate 11b, the light guide plate section 13 is provided above the measurement substrate 11b, and a microplate 20 can be installed on the upper part of the light, guide plate section 13 in the housing 15.

Also, the microplate reader 10 according to the present embodiment is configured such that the light emitting substrate 11a is disposed above the microplate 20 installed on the upper part of the light guide plate section 13. The plurality of light sources 12a are provided on the light emitting substrate 11a, and the light emitting substrate 11a is disposed such that the light sources 12a face the microplate 20.

### Microplate

The microplate 20 is a flat member made of, for example, acrylic, polyethylene, polystyrene, or glass, or the like. As shown in FIG. 2, the microplate 20 is, for example, a rectangular shaped flat plate, and has a number of wells 21 on the surface thereof. The shape of the wells 21 is, for example, a cylindrical shape with a flat bottom. The number of wells 21 may be 6, 24, 96, 384, 1536, etc., and the volume can be from several microliters (μl) to several milliliters (ml). The microplate 20 shown in FIG. 2 is a 96-well microplate of 8×12.

### Light Emitting Portion and Light Receiving Portion

The light source 12a is a light emitting portion that emits light and is disposed on one surface (lower surface) of the light emitting substrate 11a. The light receiving sensor 12b is a light receiving portion that receives light and is disposed on one surface (upper surface) of the measurement substrate 11b. The light source 12a is, for example, a light emitting diode (LED), and the light receiving sensor 12b is, for example, an RGB color sensor. The light source 12a may be, for example, a chip LED (surface-mounted LED). In this case, one light source 12a includes a chip LED having a plurality of light emitting parts (light emitting points).

The microplate reader 10 includes the same number of light sources 12a and light receiving sensors 12b, respectively, as the wells 21 of the microplate 20. In other words, one light source 12a and one light receiving sensor 12b are provided for one well 21 of the microplate 20. For example, as shown in FIG. 2, when the microplate 20 has 96 wells, 96 light sources 12a are provided on the light emitting substrate 11a, and 96 light receiving sensors 12b are provided on the measuring substrate 11b.

### Light Emitting Substrate and Measurement Substrate

The light emitting substrate 11a has a power supply line for light sources to which the light sources 12a are connected. The plurality of light sources 12a are connected to the power supply line for light sources provided on the light emitting substrate 11a and supplied with power from the power supply line for light sources. Power is supplied from the power supply unit 16 to the power supply line for light sources of the light emitting substrate 11a via the power supply cable 17a.

Likewise, the measurement substrate 11b has a power supply line for sensors to which the light receiving sensors 12b are connected. The plurality of light receiving sensors 12b are connected to the power supply line for sensors provided on the measurement substrate 11b and supplied with power from the power supply line for sensors. Power is supplied from the power supply unit 16 to the power supply line for sensors of the measurement substrate 11b via the power supply cable 17b.

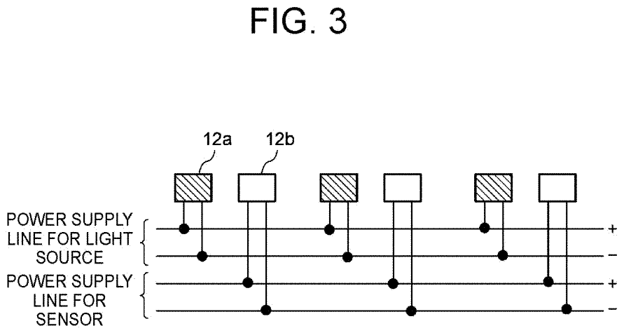

The plurality of light sources 12a are connected in parallel to the power supply line for the light sources, as shown in FIG. 3. Similarly, the plurality of light receiving sensors 12b are connected in parallel to the power supply line for the sensors, as shown in FIG. 3.

Each of the light source 12a and the light receiving sensor 12b has two wiring portions for power supply connected thereto. Therefore, when 96 light emitting portions and 96 light receiving portions are provided respectively, as in the present embodiment, 384 wires are required. In order to compactly organize such an enormous amount of wiring, the light emitting substrate 11a and the measurement substrate 11b are configured as printed circuit boards on which the above wiring patterns (power supply circuits) are formed, respectively. It should be noted that, in addition to the power supply circuit to the light receiving sensor 12b, the measurement substrate 11b may also have a sensor output circuit and a communication circuit for sensor output to the outside.

### Light Guide Plate Section

The light guide plate section 13 includes a light receiving light guide path 13a. The light receiving light guide path 13a guides the light emitted from the light source 12a on the light emitting substrate 11a, incident on (entering) the wells 21 of the microplate 20, and emitted through the sample 30 and the like contained in the wells 21 to the light receiving sensor 12b as described below.

The light guiding plate portion 13 includes the same number of the light receiving light guide paths 13a as the wells 21 of the microplate 20. In other words, one light receiving light guide path 13a is provided for one well 21 of the microplate 20. For example, as shown in FIG. 2, when there are 96 wells in the microplate 20, the light guide plate section 13 includes 96 light receiving light guide paths 13a.

The light receiving light guide path 13a is disposed in the light guide plate section 13 such that the light incident end of the light receiving light guide path 13a is positioned to correspond to the bottom face of the well 21 of the microplate 20 when the microplate 20 is placed on the light guide plate section 13. In other words, the microplate 20 is positioned by the positioning means, which is omitted in the figures, such that the bottom face of each well 21 is opposed to the light incident end of the light receiving light guide path 13a.

Also, the light receiving light guide path 13a is provided in the light guiding plate portion 13 such that the light exit end of the light receiving light guide path 13a is positioned to correspond to the light receiving sensor 12b provided on the measurement substrate 11b.

The light source 12a is provided on the light emitting substrate 11a such that the light source 12a is disposed at a position corresponding to each well 21 of the microplate 20 when the light emitting substrate 11a is disposed above the microplate 20 positioned as described above.

In a state in which the light guide plate section 13 is disposed on the measurement substrate 11b, the microplate 20 is disposed on the light guide plate section 13, and the light emitting substrate 11a is disposed above the microplate 20, the light source 12a, the light incident end of the light receiving light guide path 13a, the light exit end of the light receiving light guide path 13a, and the light receiving sensor 12b are arranged in a row in the vertical direction. Therefore, even when the wells themselves are small, such as in a 384-well microplate, it makes it possible to arrange the light emitting portion, light receiving portion, and light guiding portion to correspond to each well 21, respectively, and perform an appropriate optical measurement.

It should be noted that the arrangement of the light source 12a, the light incident end of the light receiving light guide path 13a, the light exit end of the light receiving light guide path 13a, and the light receiving sensor 12b does not need to be strictly in a row in the vertical direction. Alternatively, any arrangement can be employed as long as the light emitted from the light source 12a and passing through the sample 30 or the like contained in the wells 21 of the microplate 20 can reach the light receiving sensor 12b.

The light receiving light guide path 13a is made of a resin (e.g., silicone resin) that is transparent to light emitted from the light source 12a and passing through the sample 30 or the like contained in the wells 21 of the microplate 20. Also, the light receiving light guide path 13a is enclosed by an enclosure member 13b made of a pigment-containing resin. Here, the pigment-containing resin is a resin that contains a pigment having properties to absorb stray light in a resin having a light transmitting property (e.g., silicone resin). The above pigment can be, for example, carbon black, which is a black pigment.

According to the present embodiment, the material of the transparent resin constituting the light receiving light guide path 13a and the light transmissive resin constituting the pigment-containing resin is made the same. This suppresses reflection and scattering at the interface between the two resins. In addition, stray light incident on the pigment-containing resin is absorbed by the pigment-containing resin and hardly returns to the light receiving light guide path 13a, and complicated multiple reflections of stray light hardly occur.

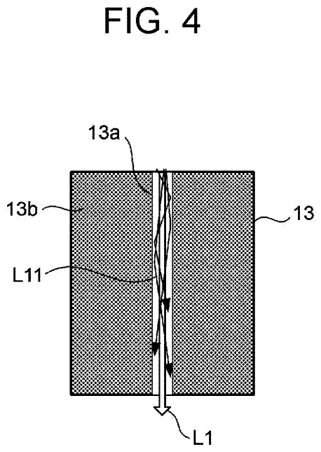

As shown in FIG. 4, among the noise light L11 such as external light entering the light receiving light guide path 13a, the component that, travels in the same direction as the optical axis of the light receiving light guide path 13a is very small, and most of the noise light enters the pigment-containing resin from the interface between the light receiving light guide path 13a and the enclosure member 13b made of pigment-containing resin and is then absorbed by the pigment. At this time, reflection at the above interface does not occur because the material of the transparent resin constituting the light receiving light guide path 13a and the pigment-containing resin constituting the enclosure member 13b is made the same.

It should be noted that the external light incident to the pigment and the scattered light thereof are mostly absorbed by the pigment concerned but are slightly scattered on the surface of the pigment. However, in many cases, the scattered light will mostly enter again the enclosure member 13b made of the pigment-containing resin, and will be absorbed by the pigment of the pigment-containing resin.

Therefore, as shown in FIG. 4, most of the light taken out from the light receiving light guide path 13a is straight traveling light L1 along the optical axis of the light receiving light guide path 13a.

Meanwhile, depending on the setting of the cross-sectional area and optical path length of the light receiving light guide path 13a, in some cases, a part of the scattered light that is slightly scattered by the pigment surface may be emitted from the light exit end of the light receiving light guide path 13a. To cope with this, it is preferable to set the cross-sectional area and optical path length of the light receiving light guide path 13a appropriately and attenuate its intensity to the extent that it does not affect the measurement.

The larger the area of the light incident end of the light receiving light guide path 13a, the larger the amount of light that enters the light receiving light guide path 13a. Therefore, as the area of the light incident end increases, the intensity of the straight traveling light traveling through the light receiving light guide path 13a and the intensity of the external light that is scattered at the light incident end of the light receiving light guide path 13a and eventually reaches the light exit end thereof as scattered light also increases.

The present inventors have investigated the dependence of the intensity of the straight traveling light with respect to the area of the light incident end of the light receiving light guide path 13a and the dependence of the intensity of the external light. As a result, it has been turned out that the amount of increase in the intensity of the external light with respect to the increase in the diameter of the light receiving light guide path 13a is greater than the increase in the intensity of the to-be-measured light (measurement light).

In other words, the narrower the area of the light incident end of the light receiving light guide path 13a is, the better the S/N ratio is. More particularly, when the ratio of the square root of the area (A) of the light incident end of the light receiving light guide path 13a with respect to the distance (L) from the light incident end to the light exit end (√A/L) is 0.4 or less, optical measurement with a sufficiently higher S/N ratio becomes possible.

For this reason, it is preferable to set the cross-sectional area and optical path length of the light receiving light guide path 13a to satisfy the above conditions. This makes it possible to appropriately suppress the adverse effects of scattered light on optical measurement.

### Arrangement of Light Sources on Light Emitting Substrate

As described above, one light source 12a and one light receiving sensor 12b are arranged correspondingly to one well 21 of the microplate 20. In other words, light emitted from one light source 12a is irradiated to the sample 30 contained in the well 21 of the microplate 20, passes through the sample 30 and the well 21, and enters the light receiving light guide 13a, and the light emitted from the light receiving light guide path 13a is sensed by one light receiving sensor 12b.

Even if some of the light, emitted from other light sources 12a adjacent to the one light source 12a passes through the sample 30 and the well 21 and enters the light receiving light guide path 13a as external light, most of the light subsequently enters the pigment-containing resin from the interface between the light receiving light guide path 13a and the enclosure member 13b made of pigment-containing resin, as shown in FIG. 4, and is absorbed by the pigment.

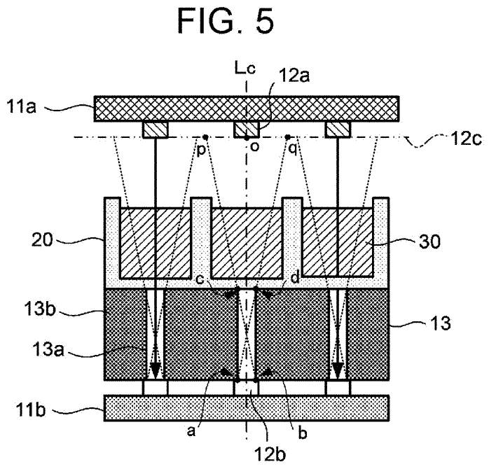

However, as shown in FIG. 5, when the points where the longitudinal cross-sectional surface of the light receiving light guide path 13a intersects with the surface of the light exit side of the light guide plate section 13 are defined as a and b, respectively, and the points where the longitudinal cross-sectional surface of the light receiving light guide path 13a intersects with the surface of the light incident side of the light guide plate portion 13 are defined as c and d, respectively, for example, external light passing through line segment ad or external light passing through line segment be is emitted outside the light receiving light guide path 13a without entering the interface between the light receiving light guide path 13a and the enclosure member 13b.

In other words, as shown in FIG. 5, when the point where the light emitting surface 12c on which the light emitters of a plurality of light sources 12a are located intersects with the optical axis Lc of the light receiving light guide path 13a is defined as o, the point where the extension of line segment ad intersects with the light-emitting surface 12c is defined as q, and the point where the extension of line segment be intersects with the light emitting surface 12c is defined as p, at least a part of the light emitted from the circular region with the center o and the diameter pq on the light emitting surface 12c is likely to be emitted to the outside from the light exit end of the light receiving light guide path 13a without entering the interface between the light receiving light guide path 13a and the enclosure member 13b. In other words, such light does not enter the enclosure member 13b, which is made of pigment-containing resin, and is therefore not absorbed by the pigment.

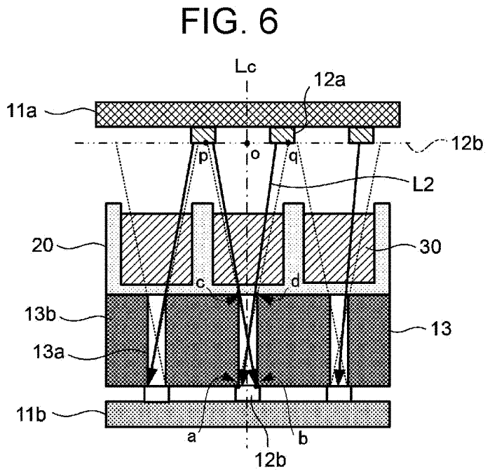

For example, as shown in FIG. 6, assuming that the light emitters of two light sources 12a are arranged in a circular region with center o and diameter pq, at least a part of the light emitted from those two light sources 12a reaches one light receiving sensor 12b without entering the enclosure member 13b made of pigment-containing resin. In this case, out of the two light sources 12a, the light emitted from one of the above two light sources 12a and reaching the above one light receiving sensor 12b becomes external light (i.e., noise light). As a result, the optical measurement accuracy becomes lower.

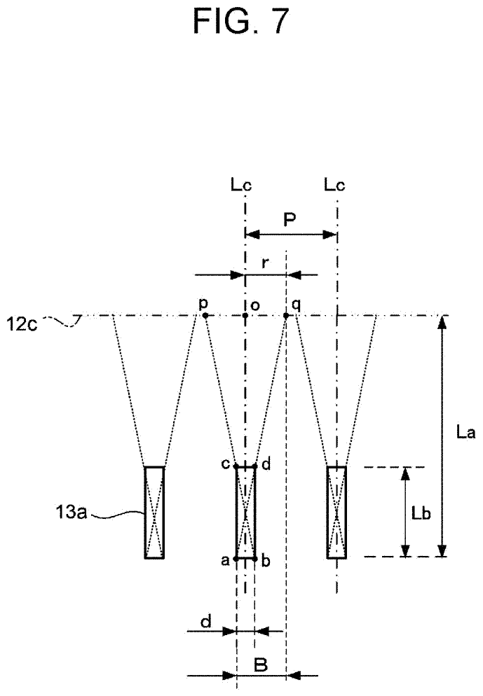

The details are shown in FIG. 7. Assuming that the light receiving light guide path 13a is cylindrical in shape, the distance from the light emitting surface 12c to the light exit surface (line segment ab) of the light receiving light guide path 13a is defined as La, the optical path length of the light receiving light guide path 13a is defined as Lb, and the diameter of the light receiving light guide path 13a is defined as d, then the radius r of the circular region with center o and diameter pq can be expressed by the following equation.

r=d(La/Lb−1/2) . . . (1)

Accordingly, when each light source 12a is arranged on the light emitting substrate 11a such that there is only one light emitter of one light source 12a within a circular region with center o and radius r on the light emitting surface 12c, light from other adjacent light sources 12a will not directly reach the light receiving sensor 12b as external light.

For this reason, according to the present embodiment, the arrangement of each light source 12a is defined such that only one light emitter of each light source 12a lies within the above circular region, taking into account the shape of the light receiving light guide path 13a. This prevents light from other adjacent light sources 12a from reaching the light receiving sensor 12b directly as external light without being absorbed by the pigment-containing resin that encloses the light receiving light guide path 13a. Therefore, even when the wells themselves are small, such as in a 384-well microplate, and a plurality of light sources 12a need to be placed in close proximity to correspond to respective wells, it makes it possible to prevent light from other adjacent light sources 12a from adversely affecting the measurement results so that measurement errors can be appropriately reduced.

When the center of each well 21 coincides with the optical axis Lc of each light receiving light guide path 13a, it is preferable to have P>2r where the pitch between wells 21 is P. In this case, the above circular regions corresponding to respective light receiving light guide paths 13a will no longer overlap. Therefore, considering the pitch P between the wells 21 of the microplate 20, it is preferable to arrange the light sources 12a such that only one light emitter of the light source 12a lies within the above circular region.

Next, how to set up the microplate reader 10 according to the present embodiment will be described.

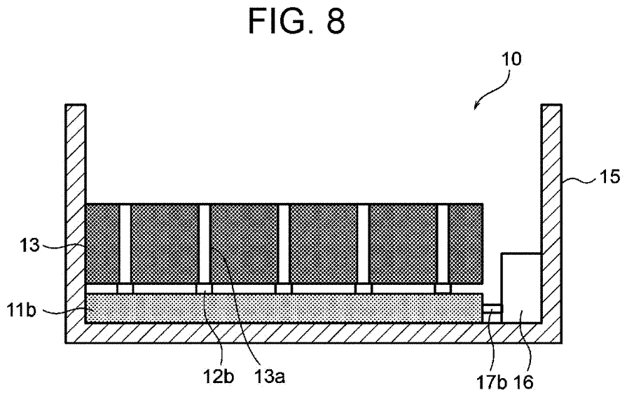

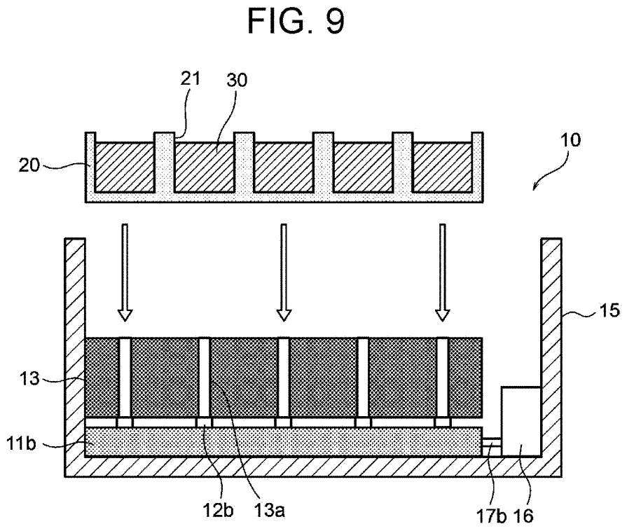

As shown in FIG. 8, for the microplate reader 10 in which the measurement substrate 11b, a plurality of light receiving sensors 12b, the light guide plate section 13, the power supply unit 16, and the power supply cable 17b are fixed inside the housing 15, the operator installs the microplate 20 with the sample 30 in each well 21 as shown in FIG. 9. At this time, the microplate is placed on the light guide plate section 13. At this time, the microplate 20 is positioned such that the bottom face of each well 21 is located at a position facing the light incident end of the light receiving light guide path 13a one by one.

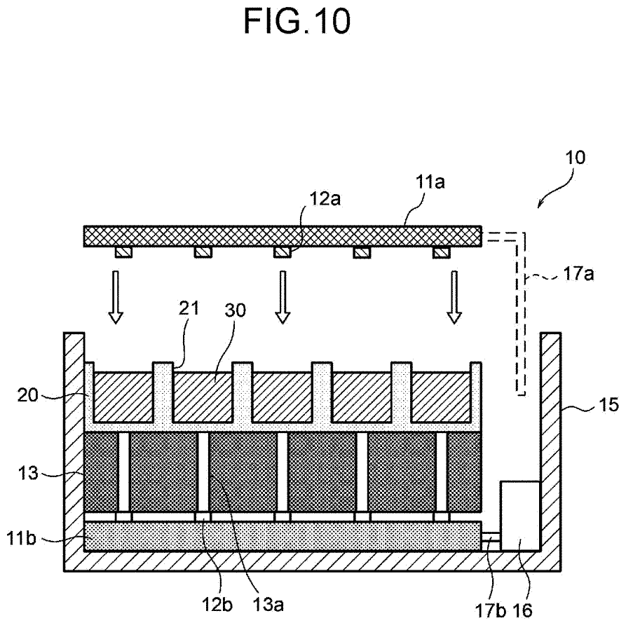

Next, as shown in FIG. 10, the operator sets up the light emitting substrate 11a above the microplate 20. At this time, the operator sets up the light emitting substrate 11a above the microplate 20 such that each of the plurality of light sources 12a on the light emitting substrate 11a is placed one by one at the position corresponding to each well 21 of the microplate 20. Here, the plurality of light sources 12a on the light emitting substrate 11a is set up in advance to have the distance between the adjacent light sources 12a such that each of the light sources 12a is arranged at a position corresponding to each well 21 of the microplate 20 when the light emitting substrate 11a is positioned above the microplate 20.

More particularly, each light source 12a is set up to have the distance between the light source 12a and the adjacent light source 12a such that only one light emitter of the light source 12a is disposed in the circular region with the center o and radius r described above. It should be noted that the light emitting substrate 11a may be positioned in the vertical direction by a positioning member not shown.

After installing the light emitting substrate 11a above the microplate 20, the operator connects the light emitting substrate 11a to the power supply unit 16 by means of the power supply cable 17a. Subsequently, the operator operates the power switch (not shown) to supply power from the power supply unit 16 to respective light sources 12a and respective light receiving sensors 12b via the power supply cables 17a and 17b. This causes light to be emitted from each light source 12a.

The light emitted from each light source 12a passes through the sample 30 contained in each well 21 of the microplate 20. The light that has passed through each well 21 passes through each light receiving light guide path 13a of the light guide plate section 13 and is received by the light receiving sensor 12b. In this way, the optical properties (e.g., light absorbing property) of the sample 30 are measured.

The measurement results by the light receiving sensor 12b may be transmittable as light intensity information to an external device via a data communication unit (not shown). In this case, the external device measures the optical properties of the sample 30 based on the above light intensity information.

As described above, the microplate reader 10 according to the present embodiment includes the same number of sets of the light source 12a as a light emitting portion, which is disposed above the horizontally disposed microplate 20 and corresponds to one well 21 of the microplate 20, and the light receiving sensor 12b as a light receiving portion, which is disposed below the horizontally disposed microplate 20 and corresponds to one well 21 of the microplate 20, as the wells 21 of the microplate.

The microplate reader 10 further includes a light guide plate section having a light receiving light guide path 13a, which is disposed between the light receiving sensor 12b and the microplate 20 and guides light emitted from the light source 12a and passed through the sample 30 contained in the well 21 to the light receiving sensor 12b, and an enclosure member 13b, which encloses the light receiving light guide path 13a by a pigment-containing resin.

Furthermore, the microplate reader 10 is configured such that the light that passes through one light receiving light guide path 13a and reaches one light receiving sensor 12b constitutes the light emitted from one light source 12a.

As described above, according to the microplate reader 10 of the present embodiment, the light sources 12a configured to irradiate the samples 30 contained in respective wells 21 with light and a light receiving sensors 12b configured to measure the light emitted from the samples 30 are provided corresponding to all of the wells 21 of the microplate 20.

Conventionally, there was no idea to install light sources and light receiving sensors corresponding to all of the wells 21 of a microplate 20, and the microplate 20 was scanned each time for each optical measurement, and the optical measurement of all wells was required to be performed by a plurality of measurements. Therefore, it took a long time to measure the light of all wells.

On the other hand, according to the present embodiment, it makes possible to perform optical measurement of all the samples 30 contained in all wells 21 of the microplate 20 almost simultaneously in one measurement without scanning the microplate 20 for each optical measurement unlike in the conventional method. Therefore, the measurement time can be shortened. In addition, the size of the device can be reduced because there is no need for a complicated driving mechanism to scan the microplate 20.

Furthermore, the light guide plate section 13 has a configuration in which the light receiving light guide path 13a, which is composed of a transparent resin (e.g., silicone resin), is enclosed by the enclosure member 13b, which is composed of a pigment-containing resin capable of absorbing external light and scattered light. Therefore, it makes it possible to suppress the influence of noise light (i.e., stray light) from the above external light and scattered light.

In particular, by using the same material for the above transparent resin and the pigment-containing resin, it makes it possible to appropriately suppress reflection and scattering at the interface of the two resins. In other words, stray light incident on the pigment-containing resin is absorbed by the pigment-containing resin and hardly returns to the light guide path, and complicated multiple reflections of stray light hardly occur. Also, by setting the cross-sectional area and optical path length of the light receiving light guide path 13a as appropriate, it makes it possible to significantly suppress the influence of external light.

In other words, even if the external light enters the inside of the device, the influence of the external light is significantly attenuated in the light receiving light guide path 13a in the light guide plate section 13. Therefore, there is no need to take strict measures to prevent noise light from entering the optical system inside the microplate reader, and the device itself does not need to be large to prevent noise light.

The above described technology of monolithic optical system using silicone resin is called Silicone Optical Technologies (SOT). According to the present embodiment, by adopting the SOT structure for the optical system of the microplate reader, the influence of external light (noise light) can be almost negligible, and the microplate reader can be made smaller and with more accurate optical measurement.

The microplate reader 10 also includes the housing 15 inside which the microplate 20 is disposed. The housing 15 may be made, for example, of a material having light shielding or heat insulating properties. In this case, it makes it possible to suppress the influences of external light incident from the sides of the microplate 20 and outside temperature. Therefore, the reliability of the measurement data of the wells 21 located at the edge of the microplate 20 can be ensured.

Yet furthermore, the light sources 12a are arranged such that there is only one light source 12a on the light emitting surface 12c within a circular region with radius r defined by the above equation (1) and centered on the point o shown in FIG. 7. In other words, only one light source 12a is disposed in the region where light can be directly incident on one light receiving sensor 12b. In this way, by defining the arrangement position of the light source 12a based on the shape of the light receiving light guide path 13a, the light emitted from a plurality of light sources 12a is prevented from entering one light receiving sensor 12b. In other words, the light sources 12a are configured such that the light that passes through one light receiving light guide path 13a and reaches one light receiving sensor 12b is the light emitted from one light source 12a.

As a result, even when the wells themselves are small, for example, in a 364-well microplate, and the distance between the centers of the wells is short (e.g., 4.5 mm), and a plurality of light sources 12a need to be disposed in close proximity to each other corresponding to respective wells, the influence of stray light can be suppressed so as to enable appropriate optical measurement.

As described above, the microplate reader 10 according to the present embodiment is small enough to be portable in fields such as POCT testing and can perform optical measurements of all the samples 30 contained in all the wells 21 of the microplate 20 in a short time with higher accuracy.

As described above, the microplate reader 10 according to the present embodiment is capable of acquiring measurement data for ail wells 21 of the microplate 20 almost simultaneously. However, the processing of measurement data is not necessarily performed simultaneously. For example, one data processing may be performed for eight wells, and this may be performed 12 times. In this case, the data processing time will take some time.

To cope with the above demand, the microplate reader 10 may have a structure that allows the measurement data corresponding to respective wells 21 to be processed simultaneously in a batch.

In this case, as shown in FIG. 11, the microplate reader 10 may have a structure in which an optical fiber 51 receives light emitted from the sample 30 contained in each well 21 and guided by the light receiving light guide path 13a. In other words, the front end (light incident end) 51a of the optical fiber 51 may be arranged as the light receiving portion instead of the light receiving sensor 12b.

Respective optical fibers 51, each of which receives light passing through the light receiving light guide path 13a corresponding to each well 21, can be bundled at the light exit end side. In this case, the light emitted from the optical fiber bundle of respective optical fibers 51 can be captured by an image sensor 52. The image data captured by the image sensor 52 is the optical measurement data corresponding to all wells 21 of the microplate 20, and by computing and processing the image data, it makes it possible to simultaneously process the optical measurement data corresponding to all wells 21 at once.

According to the present embodiment, it has been described a case where the microplate reader 10 has a structure in which the light guide plate section 13 is disposed above the light receiving portion comprising a light receiving sensor 12b, the microplate 20 is disposed above the light guide plate section 13, and the light source 12a is arranged above the microplate 20. In other words, the microplate reader 10 described above has a structure in which light is irradiated from above the wells 21 of the microplate 20 and the light passing through the wells 21 is received at the bottom side of the wells 21.

However, alternatively, another structure may be employed in which light is irradiated from below the wells 21 of the microplate 20 and the light that passes through the wells 21 is received above the wells 21.

### Second Embodiment

Hereinafter, a second embodiment according to the present invention will be described in detail.

In the first embodiment described above, a microplate reader compatible with a microplate with a predetermined number of wells (e.g., 96 wells) has been described. In the second embodiment, a microplate reader compatible with microplates with different number of wells will be described.

For example, when cell culture is performed using a microplate and optical measurement is performed on the cultured cells, a microplate with a smaller number of wells (e.g., 6 wells) is used. In order to cope with such different types of microplates, a microplate reader in unit (i.e., microplate reader unit) corresponding to solely one well is used according to the present embodiment.

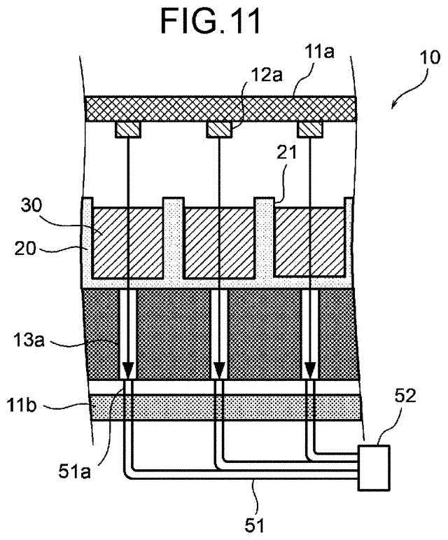

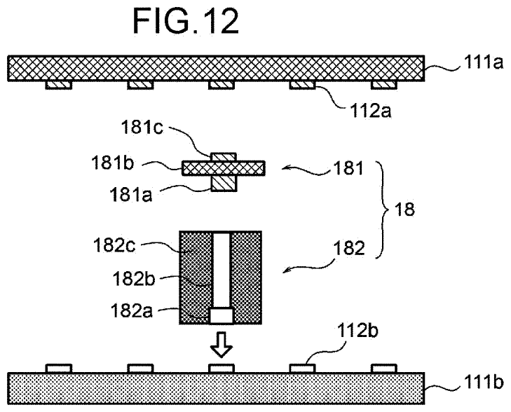

FIG. 12 is a view showing an exemplary configuration of a microplate reader unit 18.

As shown in FIG. 12, the microplate reader unit 18 includes a unit light source section 181 and a unit light guide section 182. The unit light source section 181 includes a light source 181a, a holding substrate 181b provided with the light source 181a, and a connector 181c for the light source. The unit light guide section 182 includes a light receiving sensor 182a, a light, receiving light guide path 182b, and an enclosure member 182c.

Here, the light source 181a and the light receiving sensor 182a are the same as the light source 12a and the light receiving sensor 12b in the first embodiment described above. Also, the light receiving light guide path 182b and the enclosure member 182c are the same as the light receiving light guide path 13a and the enclosure member 13b constituting the light guiding plate section 13 in the first embodiment described above.

In the unit light source section 181, the light source 181a and the connector 181c for the light source are provided on substantially the same axis, for example, across the holding substrate 181b, and both are electrically connected. The unit light source section 181 is configured to be detachable from the light emitting substrate 111a.

The light emitting substrate 111a has a configuration in which a light source connector 112a that can be electrically connected to the connector 181c for the light source of the unit light source section 181 is provided on the surface of a substrate similar to the light emitting substrate 12a in the first embodiment described above. A power supply circuit is formed on the surface of the substrate of the light emitting substrate 111a, and the light source connector 112a is electrically connected to the power supply circuit. Therefore, when the connector 181c for the light source of the unit light source section 181 is attached to the light source connector 112a of the light emitting substrate 111a, the light source 181a is electrically connected to the light source connector 112a via the connector 181c for the light source.

The unit light guide section 182 is configured to be detachable from the measurement substrate 111b.

The measurement substrate 111b has a configuration in which a connector 112b for the sensor that can be electrically connected to the light receiving sensor 182a of the unit light guide section 182 is provided on the surface of the substrate similar to the measurement substrate 11b in the first embodiment described above. A power supply circuit is formed on the surface of the substrate of the measurement substrate 111b, and the connector 112b for the sensor is electrically connected to the power supply circuit.

The light emitting substrate 111a and the measurement substrate 111b are aligned and installed so as to have a certain positional relationship with the microplate.

In this three-way alignment state, there are 96 connectors 112a for the light source and 96 connectors 112b for the sensor on the light emitting substrate 111a and on the measurement substrate 111b, respectively, so as to correspond to all wells of a 96-well microplate, for example.

More particularly, the connector 112a for the light source is provided at a position on the light emitting substrate 111a corresponding to the light source 12a shown in FIG. 2, for example. Likewise, the connector 112b for the sensor is provided at a position on the measurement substrate 111b corresponding to the light receiving sensor 12b shown in FIG. 2, for example.

The microplate reader unit 18, including a unit light source section 181 and a unit light guide section 182, has a size corresponding to one well of a 96-well microplate. A maximum of 96 unit light source sections 181 can be mounted on the light emitting substrate 111a, corresponding to all wells of a 96-well microplate. Similarly, a maximum of 96 unit light guide sections 182 can be mounted on the measurement substrate 111b, corresponding to all wells of a 96-well microplate.

When the 96 unit light source sections 181 are mounted to respective 96 light source connectors 112a on the light emitting substrate 111a, the light sources 181a, the light, source connectors 181c, and the light source connectors 112a are arranged on substantially the same axis, and the light sources 131a are arranged at the positions corresponding to the 96 wells 21 of the microplate, respectively. Similarly, when the 96 unit light guide sections 182 are mounted to respective 96 sensor connectors 112b on the measurement substrate 111b, the light receiving sensors 182a are arranged at the positions corresponding to the 96 wells 21 of the microplate, respectively.

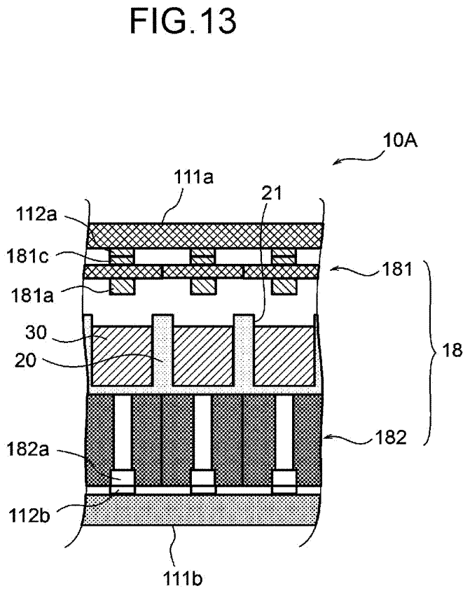

FIG. 13 is a diagram showing an exemplary microplate reader 10A according to the present embodiment, in which, of the microplate reader units 18, a plurality of unit light source sections 181 are mounted adjacent to each other on the light emitting substrate 111a and a plurality of unit light guide sections 182 are mounted adjacent to each other on the measuring substrate 111b. As shown in this FIG. 13, the structure in which a plurality of microplate reader units 18 are connected to the light emitting substrate 111a and the measurement substrate 111b has a similar structure to a part of the microplate reader 10 in the first embodiment shown in FIG. 1 (i.e., the light emitting substrate 11a, the light source 12a, the measurement substrate 11b, the light receiving sensor 12b and the light guide plate section 13).

Therefore, the microplate reader 10A with 96 microplate reader units 18 being connected to the light emitting substrate 111a and the measurement substrate 111b has the similar structure to the microplate reader 10 in the first embodiment shown in FIG. 1.

Although FIGS. 12 and 13 show an example in which the microplate reader unit 18 is a microplate reader in unit corresponding to only one well 21, the present embodiment is not limited thereto, and the microplate reader unit 18 may be a microplate reader in unit corresponding to a plurality of wells 21. Also, at least one of the unit light source section 181 and the unit light guide section 182 constituting the microplate reader unit 18 may correspond to a plurality of wells 21. For example, the unit light guide section 182 may be a unit corresponding to eight wells 21, and thus 12 unit light guide sections 182 may be used for a 98-well microplate 20.

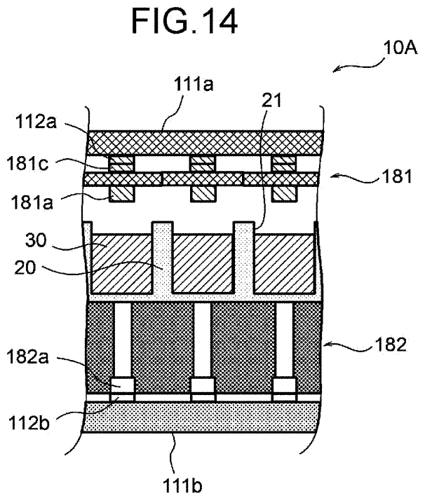

FIG. 14 shows an example in which the unit light source section 181 corresponds to only one well 21 and the unit light guide section 182 corresponds to a plurality of wells 21.

The microplate reader 10A according to the present embodiment is constituted by arranging the microplate reader units 18 as appropriate depending on the number and positions of wells 21 of the microplate 20 used for optical measurement.

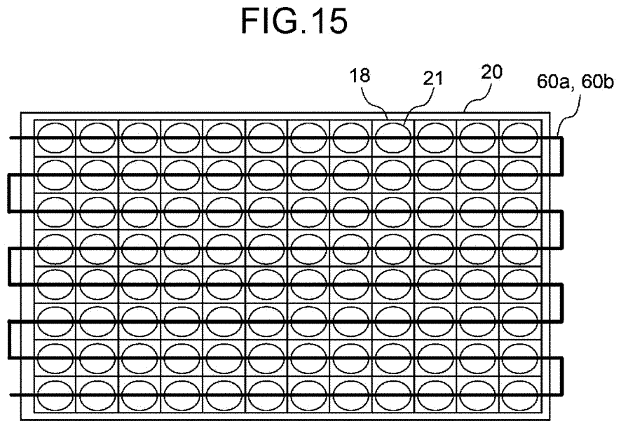

For example, when a 96-well microplate 20 is used, 96 microplate reader units 18 are arranged at the positions corresponding to the 96 wells 21, respectively, as shown in FIG. 15. Among those 96 microplate reader units 18, the unit light source section 181 is connected to the wiring 60a formed on the light emitting substrate 111a and is configured to be supplied with electric power. Similarly, the unit light guide section 182 is connected to the wiring 60b formed on the measurement substrate 111b and is configured to be supplied with electric power. Here, a multi-drop connection or a daisy chain connection can be used as the connection method of the wiring 60a and 60b.

On the other hand, when a six-well microplate 20 is used, six microplate reader units 18 are arranged at the positions corresponding to the six wells 21, respectively, as shown in FIG. 16. In this case also, among those six microplate reader units 18, the unit light source section 181 is connected to the wiring 60a formed on the light emitting substrate 111a and is configured to be supplied with electric power. Similarly, the unit light guide section 182 is connected to the wiring 60b formed on the measurement substrate 111b and is configured to be supplied with electric power.

Although, in FIG. 16, a case in which one microplate reader unit 18 is arranged for one well 21 is described, a plurality of microplate reader units 18 may be arranged for one well 21. In this case, the statistics of the measurement data of the plurality of microplate reader units 18 corresponding to one well 21 may be adopted as the measurement data for that one well 21.

As described above, the microplate reader unit 10A according to the present embodiment has a configuration in which the necessary number of the microplate reader units 18 are at the necessary positions on the light emitting substrate 111a and the measurement substrate 111b depending on the number and positions of the wells 21 of the microplate 20. Therefore, it makes it possible to provide the microplate reader corresponding to microplates with different numbers of wells.

Although in the present embodiment a certain case has been described in which the microplate reader unit 18 includes the light emitting portion, a light receiving portion, and a light guide plate section, the microplate unit 18 may also include up to a substrate with wiring connected to the light source 181a, which constitutes the light emitting portion, and the light receiving sensor 182a, which constitutes the light receiving portion, respectively. In this case, when the microplate reader unit 18 is arranged to correspond to the number and positions of the wells 21 of the microplate 20, the above described substrate constituting the unit may have any configuration that is connectable to the power supply cable connected to the power supply unit.

### Modifications to Embodiments

In the embodiments described above, a certain case has been described in which the light receiving light guide paths (13a, 182b) are formed of a transparent resin. Nevertheless, those light receiving light guide paths may be hollow. In this case, although the effect of suppressing stray light reflection at the interface between the light receiving light guide path and the enclosure members (13b, 182c) made of pigment-containing resin enclosing the light receiving light guide path is not obtained, the stray light incident on the pigment-containing resin is absorbed by the pigment-containing resin, so that the complicated multiple reflection of stray light is likely to be suppressed to some extent.

In the embodiments described above, a certain case has been described in which the bottom face of the wells of the microplate 20 has a flat plate shape. Forming the bottom face of the well to have a flat plate shape is preferable because it has good contact with the light guide plate section 13, but the shape of the bottom surface of the well does not necessarily have to be a flat plate shape.

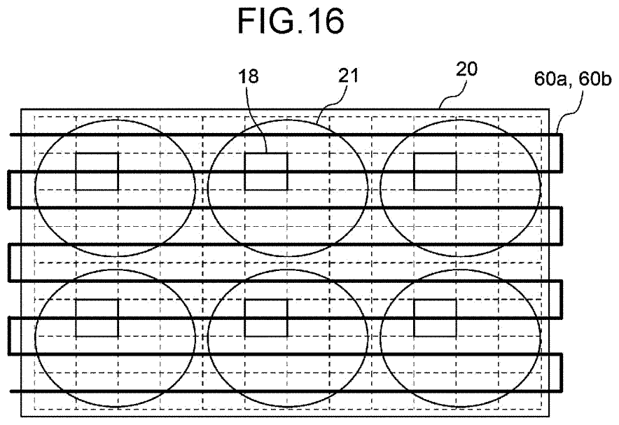

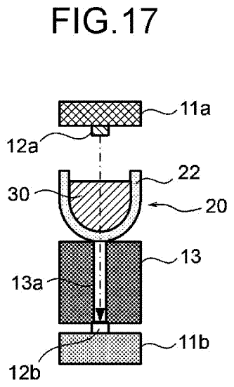

For example, as shown in FIG. 17, the shape of the bottom face of the well 22 of the microplate 20 may have a spherical shape. In this case, as a small gap is formed between the light incident end of the light receiving light guide path 13a and the bottom face of the well 22, it is possible for external light to enter the light receiving light guide path 13a. Nevertheless, by setting the cross-sectional area and optical path length of the light receiving light guide path 13a as appropriate, the intensity of the external light can be attenuated to the extent that it does not affect the measurement results.

Furthermore, in the embodiments described above, the light emitting portions (light sources) and the light receiving portions (light receiving sensors) may be individually driven one by one. In this case, depending on to the number and positions of wells in the microplate, the light emitting and receiving portions of the required number and position can also be selectively driven. This allows the microplate reader to be used for microplates with different numbers of wells.

Yet furthermore, in the embodiments described above, the number of the light emitting portions (light sources) and the light receiving portions (light receiving sensors) does not necessarily have to match the number of wells, and microplates with fewer wells than the number of the light emitting portions and the light receiving portions can be arranged.

Yet furthermore, the above embodiments described above are not necessarily limited to arranging the microplate horizontally and arranging the light emitting portion and light receiving portion in the vertical direction of the microplate, but can be suitably modified to the extent that the sample contained in the wells can be optically measured, for example, by arranging the microplate vertically or arranging the light emitting portion and light receiving portion in the oblique direction of the microplate.

Yet furthermore, although in the embodiments described above, a certain case has been described in which a chip LEDs are used as the light source, the light source may be, for example, a general-purpose LED (e.g., LED with lens).

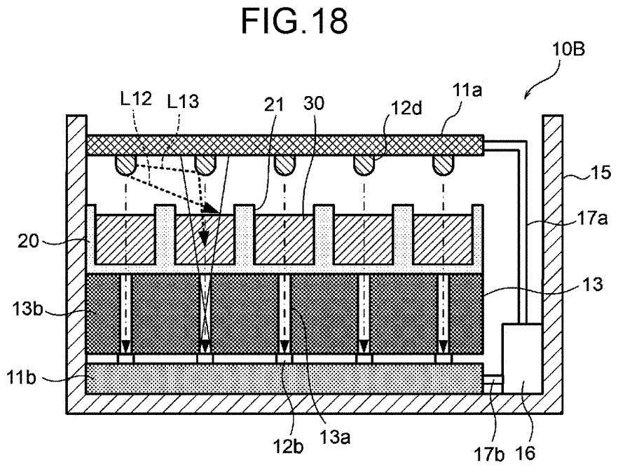

FIG. 18 is a schematical view showing an exemplary configuration of a microplate reader 10B including a light source 12d, which is a general-purpose LED. In FIG. 18, the parts having the same configuration as the microplate reader 10 shown in FIG. 1 are denoted with the same sign as in FIG. 1.

The general-purpose LEDs are larger than the chip LEDs. Therefore, for example, as shown by the arrow L12 in FIG. 13, light from one light source (the leftmost light source) 12d is more likely to enter the well 21 corresponding to the adjacent light source (the second light source from the left) 12d. Also, for example, as shown by the arrow L13, light from one light source (leftmost light source) 12d may reach the surface of an adjacent light source (second light source from the left) 12d, be reflected, and consequently enter the well 21 corresponding to the adjacent light source (second light source from the left) 12d. In this way, light from the adjacent light source 12d may enter the light receiving light guide path 13a as stray light, which is likely to adversely affect the measurement results.

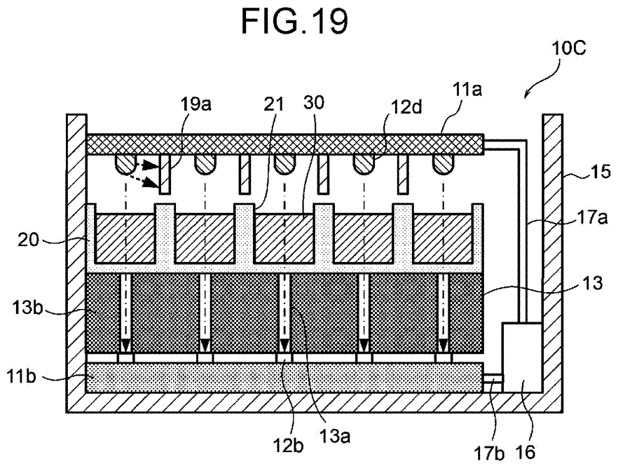

To cope with this, when a general-purpose LED is used as the light source, a shielding member 19a may be disposed between light, sources 12d adjacent to each other, as shown in FIG. 19. The shielding member 19a is a limiting member to limit light emitted from light sources 12d adjacent to one light source 12d from entering the light receiving light guide path 13a corresponding to that one light source 12d.

The shielding member 19a is made of a material that shields the light from the light source 12d. For example, the shielding member 19a can be made of a pigment-containing resin that contains a pigment having a light absorbing property. The arrangement position and shape (length and thickness) of the shielding member 19a should be set as appropriate such that light emitted from one light source 12d does not enter the well 21 corresponding to the other light sources 12d, and thus does not enter the light receiving light guide path 13a corresponding to the other light sources 12d.

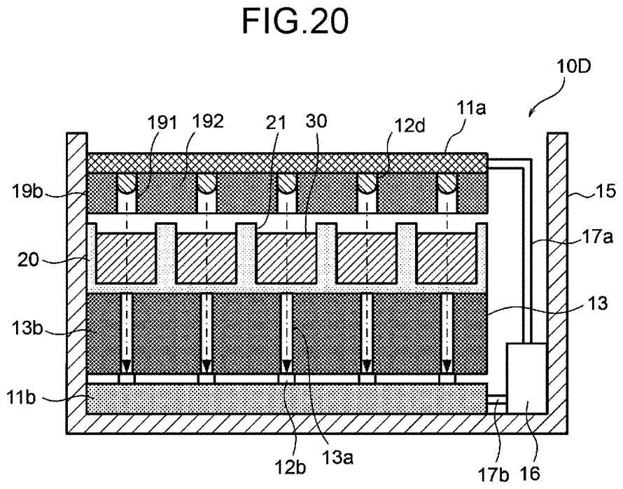

As shown in FIG. 20, a light guide plate section 19b, which has the same configuration as the light guide plate section 13 disposed between the microplate 20 and the light receiving sensor 12b, may be disposed between the light source 12a and the microplate 20.

The light guide plate section 19b includes light emitting light guide paths 191 corresponding to a plurality of light sources 12d, respectively. The light emitting light guide path 191 is made of a resin (e.g., silicone resin) that is transparent to the light emitted from the light source 12a. The light emitting light guide path 191 is enclosed by an enclosure member 192 made of a pigment-containing resin. In this case, the enclosure member 192 made of a pigment-containing resin is disposed between light sources 12d adjacent to each other and functions as a limiting member to limit light emitted from light sources 12d adjacent to one light source 12d from entering the light receiving light guide path 13a corresponding to the one light source 12d above.

In this way, by disposing the limiting member between light sources 12d adjacent to each other, it makes it possible to prevent light emitted from one light source 12d from directly entering the well 21 corresponding to other light source 12d, or from being reflected by the surface of other light source 12d and entering the well 21 corresponding to that other light source 12d. In particular, the use of the pigment-containing resin as the limiting member can appropriately absorb the light traveling from one light source 12d to other wells 21 and other light sources 12d. As a result, the light from each light source 12d can enter the sample 30 contained in each corresponding well 21 as almost straight traveling light.

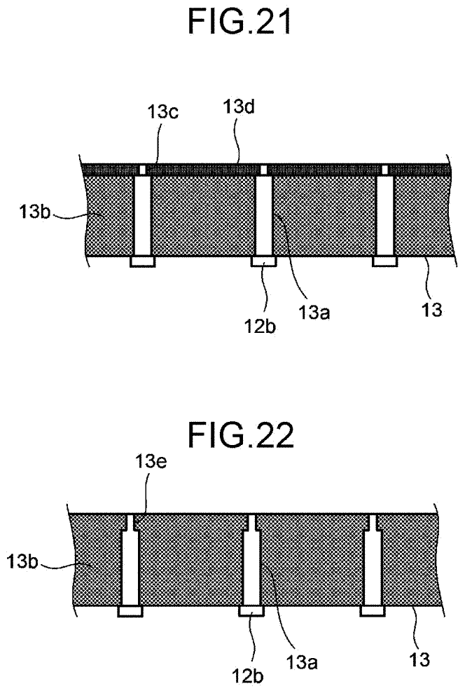

The above described limiting member may be an aperture plate 13d having an aperture 13c, which is disposed on the light source side of the light receiving light guide path 13a and limits the incident range of light entering the light receiving light guide path 13a, as shown in FIG. 21. Here, the aperture 13c has an opening smaller than the opening of the light incident end of the light receiving light guide path 13a. By arranging the aperture plate 13d in this way, the angular component of the light incident on the light receiving light guide path 13a can be limited. In this case, the incident range of light entering the light receiving light guide path 13a can be easily adjusted by setting the size of the opening 13c of the aperture plate 13d as appropriate. As a result, it makes it possible to appropriately suppress the adverse effect of stray light on the measurement results.

The above described limiting member may be a protruding portion 13e that is provided on the inner wall of the light receiving light guide path 13a and limits the width of the light receiving light guide path 13a, as shown in FIG. 22. Thus, by providing the protruding portion 13e on the inner wall of the light receiving light guide path 13a, it makes it possible to appropriately limit the light entering the light receiving light guide path 13a or the light emitted from the light receiving light guide path 13a. In this case, the width of the light receiving light guide path 13a can be easily adjusted by setting the size of the protruding portion 13e appropriately. Therefore, it makes it possible to appropriately suppress the adverse effect of stray light on the measurement results.

Although FIG. 22 shows an example in which the protruding portion 13e is provided at the light source side end of the light receiving light guide path 13a, the position at which the protruding portion 13e is provided is not limited to the position shown in FIG. 22.

When the light guide plate section 13 described above is constituted by the light receiving light guide path 13a made of a transparent resin (e.g., silicone resin) and the enclosure member 13b enclosing the light receiving light guide path 13a and made of a pigment-containing resin that can absorb external light and scattered light, the light guide plate section 13 is manufactured, for example, by the following procedure.

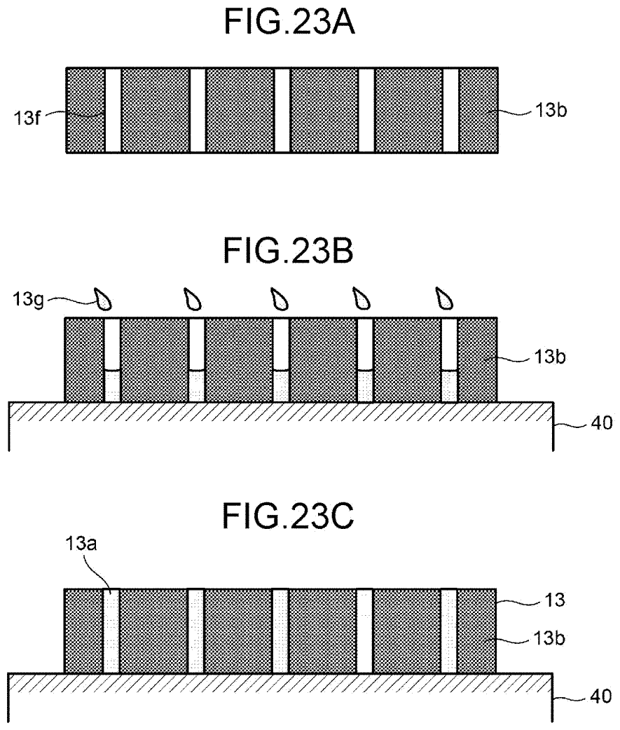

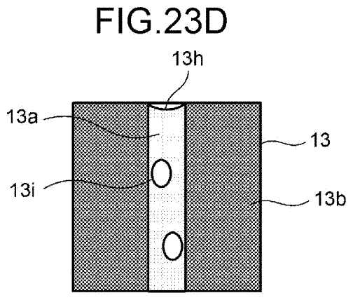

As shown in FIG. 23A, first the process molds an enclosure member made of a pigment-containing resin with a cavity 13f for the light guide path in which the light receiving light guide path will be later formed.

Next, as shown in FIG. 23B, the enclosure member 13b is placed on a platen 40 and liquid transparent resin 13g is injected into the cavity 13f for light guide path. By solidifying the transparent resin 13g, as shown in FIG. 23C, a light guide plate section 13 comprising a light receiving light guide path 13a made of a transparent resin and an enclosure member 13b made of a pigment-containing resin and enclosing the light receiving light guide path 13a is obtained.

When the present inventors have manufactured the light guide plate section 13 using the above described procedure, it has been found that the following problem occurs. That is, when the transparent resin 13g is injected into the cavity 13f for the light guide path and solidified, a front end (light incident end) 13h of the light receiving light guide path 13a does not necessarily become flat due to the influence of surface tension or the like when injecting the liquid transparent resin 13g, as shown in FIG. 23D. In such a case, for example, some of the light incident from the front end (light incident end) 13h is scattered, thus the intensity of the light taken out from the light exit end of the light receiving light guide path 13a is likely to be reduced.

Also, even when bubbles are generated inside the light receiving light guide path 13a when injecting the liquid transparent resin 13g, the generated bubbles cannot be visually confirmed because the light receiving light guide path 13a is enclosed by the enclosure member 13b. When the transparent resin 13g solidifies, the above mentioned bubbles are fixed as bubbled cavities 131 in the light receiving light guide path 13a.

When light enters the bubbled cavity 13i, the light is scattered, and some of the scattered light enters the enclosure member 13b and is absorbed by the enclosure member 13b. Therefore, the intensity of the light taken out from the light exit end of the light receiving light guide path is reduced.

In order to solve such a problem, the present inventors took the following procedure to fabricate the light guide plate section.

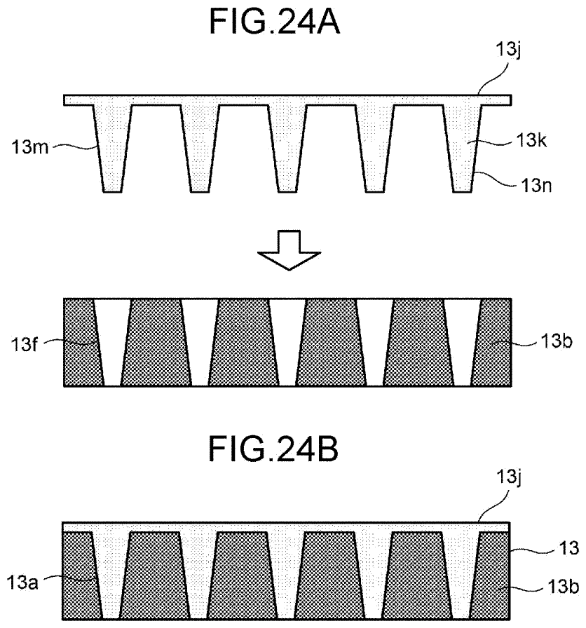

First, as shown in FIG. 24A, the process molds a transparent resin member 13m for the light guide path, which is made of a transparent resin and has a columnar part (columnar member) 13k serving as the light receiving light guide path on the flat part 13j. In this case, since the transparent resin member 13m for the light guide path is not enclosed by the enclosure member 13b, it can be visually confirmed whether or not a bubbled cavity 13i is generated in the transparent resin member 13m for the light guide path. Then the process molds the enclosure member 13b made of a pigment-containing resin with the cavity 13f for the light guide path in which the columnar part 13k is accommodated.

Subsequently, by fitting the transparent resin member 13m for the light guide path into the enclosure member 13b such that the columnar part 13k of the transparent resin member 13m for the light guide path is inserted into the cavity 13f of the enclosure member 13b, as shown in FIG. 24B, the light guide plate section 13 comprising the light receiving light guide path 13a made of a transparent resin and the enclosure member 13b made of a pigment-containing resin and enclosing the light receiving light guide path 13a is obtained.

It is preferable that the columnar part 13k of the transparent resin member 13m for the light guide path has a truncated cone shape with a tapered part 13n being provided on the side so that the transparent resin member 13m for the light guide path is smoothly fitted into the enclosure member 13b.

In the light guide plate section 13 shown in FIG. 24B, the upper surface of the light guide plate section 13 has a flat part 13j made of transparent resin, and the lower surface of the flat part 13j is optically continuously connected to the light receiving light guide path 13a. Therefore, by arranging the flat part 13j on the light incident side, the scattering of light incident on the flat part 13j is suppressed as compared to the scattering of light incident on the front end (light incident end) 13h of the light guide plate section 13 shown in FIG. 23D. Therefore, it makes it possible to suppress the intensity of the light taken out from the light exit end of the light receiving light guide path 13a of the light guide plate 13 from being reduced.

Furthermore, since the transparent resin member 13m for the light guide path, which serves as the light receiving light guide path, and the enclosure member 13b are molded separately, it makes it possible to visually confirm whether or not a bubbled cavity 13i is generated in the transparent resin member 13m for the light guide path. By combining the transparent resin member 13m for the light guide path, which is confirmed not to have the bubbled cavity 13i, and the enclosure member 13b to form the light guide plate section 13, it makes it possible to avoid light scattering caused by the bubbled cavity 13i.

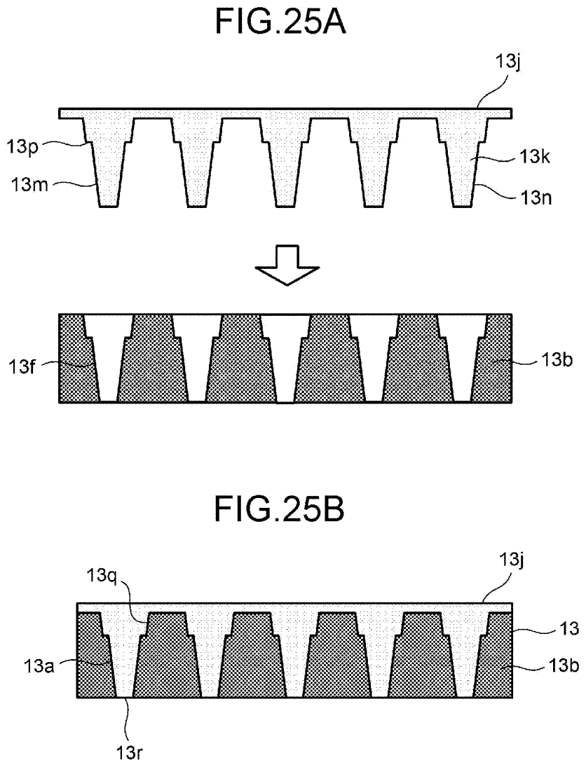

In order to reduce the influence of external light entering the light guide plate section 13, as shown in FIG. 25A, a stepped portion 13p may be provided at the connecting part between the flat part 13j and the truncated cone-shaped columnar part 13k such that the diameter of the connecting part side is larger than that of the front end (tip) side of the columnar part 13k. As shown in FIG. 25B, the upper part 13q of the side wall of the enclosure member 13b made of pigment-containing resin, which is illuminated by external light may be hidden from the light receiving sensor disposed on the light exit end 13r side.

### Application Examples

As described above, the microplate reader according to the embodiments described above encloses the light receiving light guide path by the enclosure member made of a pigment-containing resin capable of absorbing external light and scattered light, so that external light, scattered light, and the like can be suppressed from entering the light receiving portion as stray light (i.e., noise light). In addition, the light emitted from a plurality of light emitting portion can be prevented from passing through one light receiving light guide path and reaching the light receiving portion, thus appropriately reducing the measurement error. Therefore, highly accurate measurement is possible.

Such a structure can be applied, for example, to a method in which a microplate is scanned relative to a set of the light emitting portion, the light receiving portion, and the light receiving light guide path (hereinafter referred to as a “scanning type”).

A scanning type microplate reader requires a driving mechanism to relatively scan the microplate, and the device itself becomes generally larger. In addition, conventional microplate readers may cause complicated multiple reflections of stray light, and the optical system must be designed in consideration of the multiple reflections.

On the other hand, by employing the optical system configuration (i.e., SOT structure) of the above described embodiments, it makes it possible to eliminate necessity of designing the optical system to deal with stray light generated by multiple scattering or the like, unlike the conventional scanning type microplate reader. As the SOT structure is relatively simple in construction, the scanning type microplate reader employing the SOT structure can be smaller as compared to the conventional scanning type microplate reader. In addition, the adoption of the SOT structure can improve the accuracy of measurement compared to conventional methods.

Hereinafter, the configuration of the scanning type microplate reader will be described.

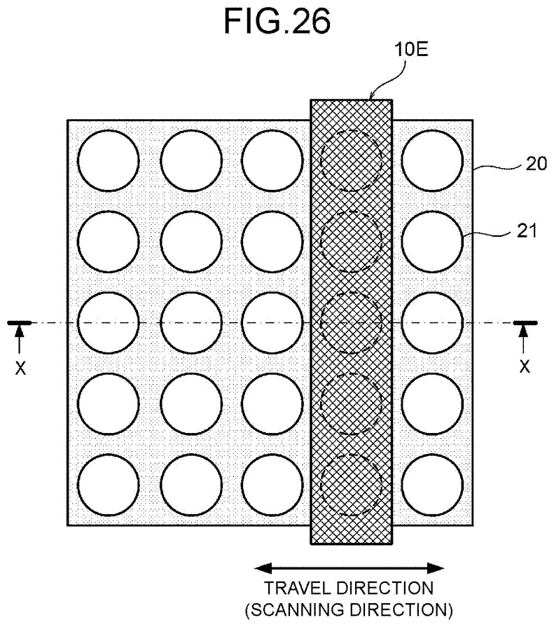

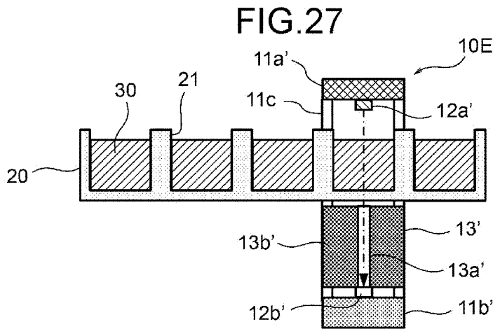

FIGS. 26 and 27 illustrate a main portion of a scanning type microplate reader 10E employing the SOT structure. Here, FIG. 27 is a cross-sectional view taken along line X-X of FIG. 26. The detailed description is omitted for the same components as in the above described embodiments.

As shown in FIG. 27, the microplate reader 10E includes a light emitting substrate 11a′, a measurement substrate 11b′, a light source 12a′, a light receiving sensor 12b′, and a light guide plate section 13′. A plurality of light receiving sensors 12b′ are provided on the measurement substrate 11b′, and a light guide plate section 13′ is provided on the measurement substrate 11b′. The light guide plate section 13′ has a structure in which a plurality of light receiving light guide paths 13a′ are enclosed by an enclosure member 13b′ made of a pigment-containing resin.

The light emitting substrate 11a′ is disposed above the light guide plate section 13′ across a gap with a certain distance therebetween, and a plurality of light sources 12a′ are provided on the light emitting substrate 11a′.

The measurement substrate 11b′, the light guide plate section 13′, and the light emitting substrate 11a′ are integrally held together by, for example, a support member (e.g., a pillar) 11c.

The microplate 20 is inserted into the gap with a certain interval between the light guide plate section 13′ and the light emitting substrate 11a′. In other words, the spacing of the above gap is set to be larger than the thickness of the microplate 20 so that the microplate 20 can be inserted into the gap.

In a state in which the microplate 20 is inserted and positioned in the above gap, the plurality of light sources 12a′ provided on the light emitting substrate 11a′ are positioned so as to face the predetermined plurality of wells 21 of the microplate 20 inserted in the gap, respectively. Likewise, the plurality of light receiving light guide paths 13a′ provided in the light guide plate section 13′ and the plurality of light, receiving sensors 12b′ provided on the measurement substrate 11b′ are similarly arranged so as to face the predetermined plurality of wells 21 of the microplate 20 inserted in the gap, respectively.

Here, the microplate reader 10E includes the same number of light sources 12a′, light receiving sensors 12b′, and light receiving light guide paths 13a′ as the number of wells 21 in one row of the microplate 20. In other words, one light source 12a′, one light receiving sensor 12b′, and one light receiving light guide path 13a′ are provided for respective wells in one row of microplate 20.

A plurality of sets of the light source 12a′, the light receiving light guide path 13a′ and light receiving sensors 12b′, each of which correspond to one well 21, are arranged in the column direction (the direction of one side) of the wells 21 of the microplate 20. For example, when the microplate 20 has 8×12=96 wells, the number of sets of the light source 12a′, the light receiving sensor 12b′, and the light receiving light guide path 13a′ to be arranged is 8 or 12.

Furthermore, one light source 12a′, the light incident and light exit ends in one light receiving light guide path 13a′, and one light receiving sensor 12b′ are arranged in a row in the vertical direction. Yet furthermore, the arrangement interval of the plurality of sets of the light source 12a′, the light receiving sensor 12b′, and the light receiving light guide path 13a′ is equal to the pitch between wells 21 of the microplate 20.

Therefore, by positioning the microplate 20 in the gap between the light guide plate section 13′ and the light emitting substrate 11a′, a set of the light source 12a′, the light receiving sensor 12b′ and the light receiving light guide path 13a′ are arranged to correspond to respective wells 21 in one row.

In other words, in the respective wells 21 in one row of the microplate 20, light emitted from one light source 12a′ passes through one light receiving light guide path 13a′ via a sample 30 and the like contained in one well 21, and reaches one light receiving sensor 12b′.

It makes it possible to simultaneously perform optical measurements for a single row of wells in the microplate 20.

The arrangement of the light source 12a′, the light incident and light exit ends of the light receiving light guide path 13a′, and the light receiving sensor 12b′ does not need to be strictly in a row in the vertical direction. Instead, any arrangement may suffice as long as light emitted from one light source 12a′ and passing through the sample 30 and the like contained in one well 21 of the microplate 20 can pass through one light receiving light guide path 13a′ and reach one light receiving sensor 12b′.

In the microplate reader 10E having the above configuration, by sequentially moving the microplate 20 relative to a plurality of sets of the light source 12a′, the light receiving sensor 12b′, and light receiving light guide path 13a′ arranged in the row direction of the wells 21 of the microplate 20 in a direction approximately orthogonal to the row direction of the wells 21, it makes it possible to perform optical measurement on all wells 21 of the microplate 20.

For example, for a microplate with 8×12=96 wells, when eight sets of the light source 12a′, the light receiving sensor 12b′, and the light receiving light guide path 13a′ are provided corresponding to eight wells in a row, the direction of relative sequential movement described above is the direction of aligning 12 wells 21.

The relative sequential movement described above can be performed by a moving mechanism, the illustration of which is omitted. The moving mechanism either moves the microplate 20 in a direction orthogonal to the row direction of the wells 21 or moves the sets of the light source 12a′, the light receiving light guide path 13a′ and the light receiving sensor 12b′, which are arranged in a row in the vertical direction, in a direction orthogonal to the row direction of the wells 21 while maintaining their positional relationship with each other.

FIG. 26 shows a case in which the microplate 20 is fixed and a set of the light emitting substrate 11a′, the light guiding plate section 13′, and the measurement substrate 11b′, which are integrally held by the pillar 11c, is sequentially moved by the moving mechanism.

The moving mechanism may have a control function of, for example, a servo motor or a stepping motor. When the pitch between the wells 21 of the microplate 20 is relatively large, the moving mechanism can be realised by a mechanical stopper or the like, since highly accurate position control is not required.

As described above, the scanning type microplate reader 10E can perform optical measurements for all wells 21 of the microplate 20 using fewer sets of light measurement sections (i.e., the light source 12a′, the light receiving light guide path 13a′ and the light receiving sensor 12b′) than the number of wells 21 of the microplate 20. Therefore, it makes it possible to reduce the size of the device as compared to the case in which the same number of sets of the optical measurement sections as the number of wells 21 are provided as shown in FIG. 1 and the like.

Furthermore, in the case of a configuration in which sets of the optical measurement sections are provided as many as the number of the wells 21 in one row of the microplate 20 and those sets of the optical measurement sections are moved in the direction orthogonal to the row direction of the wells 21, the moving mechanism can be configured relatively simply because the movement can be made in only one axis direction. When the sets of the optical measurement sections are moved in the orthogonal two-axis direction, the moving mechanism necessarily becomes larger in the height direction, for example, by using two-tiered guide rails, or the like. On the other hand, when the movement is only in the one-axis direction, the moving mechanism does not become larger in the height direction, and resultantly, it makes it possible to make the device thinner.

Yet furthermore, in the case of scanning type microplate readers, a predetermined gap is formed between the microplate and the optical measurement sections because the microplate and the sets of optical measurement sections need to be moved relative to each other. Therefore, external light is likely to penetrate the gap and scattered light is likely to be generated in the gap.

On the other hand, the above described microplate reader 10E employs the light guide plate section 13′ with the SOT structure, which allows only straight traveling light to be extracted. Thus, even if the gap is formed between, for example, the bottom surface of the microplate 20 and the top surface of the light guide plate 13′, the influence of stray light (i.e., noise light) such as external light and scattered light is negligible. In addition, since it is not affected by the external light, highly accurate optical measurement is possible even outside the room.

As described above, the scanning type microplate reader 10E is compact and capable of highly accurate optical measurement, so that it can be used for the on-site optical measurement where the sample to be measured is obtained. For example, it can be applied to fungal poisoning tests for imported grains at ports.

In FIGS. 26 and 27, the housing 15, the power supply unit 16, and the power supply cables 17a and 17b shown in FIG. 1 and the like are omitted. Nevertheless, when moving the light emitting substrate 11a′, the light guide plate section 13′, and the measurement substrate 11b′ by the moving mechanism as described above, the power supply cables 17a and 17b for supplying power from the power supply unit 16 to the light emitting substrate 11a′ and the measurement substrate 13b′ need be configured (e.g., in its length and arrangement) to follow the movement of the light emitting substrate 11a′, the light guide plate section 13′ and the measurement substrate 11b′.

Furthermore, in the above described microplate reader 10E, although the case of sequential movement of the sets of light measurement sections consisting of the light emitting substrate 11a′, the light guide plate section 13′, and the measurement substrate 11b′ has been described, the sets of the light measurement sections may be fixed and the microplate 20 may be moved sequentially.

It should be noted that, when moving the microplate 20, the liquid level of the liquid sample 30 contained in the wells 21 moves, and it takes time for the liquid level to stabilize. For this reason, it is preferable to move the sets of optical measurement sections instead of moving the microplate 20, because the liquid level can be kept stable and the optical measurement for all the wells 21 can be completed in a shorter time.

Furthermore, the microplate reader 10E shown in FIGS. 26 and 27 has been described in a case in which the microplate reader 10E includes the same number of the sets of optical measurement sections, each of which comprises the light source 12a′, the light receiving light guide path 13a′, and the light receiving sensor 12b′, as the wells 2.1 in one row of the microplate 20. Nevertheless, in a scanning type microplate reader, the number of sets of optical measurement sections is not limited to the above, as long as the number is less than the number of wells of the microplate 20.

For example, the number of sets of the optical measurement sections may be smaller than the number of the wells 21 in one row of the microplate 20, and the sets of the optical measurement sections may be moved sequentially in two dimensions relative to the microplate 20. In this case, the optical measurement can also be performed for all wells of the microplate 20.

Alternatively, the number of sets of the optical measurement sections may be larger than the number of wells 21 in one row of the microplate 20. For example, the number of sets of the optical measurement sections may be the same as the number of wells 21 in a plurality of rows, e.g., two or three rows, of microplate 20, and the sets of the optical measurement sections may be moved sequentially by the plurality of rows.

Furthermore, the sets of the optical measurement sections need not necessarily to be arranged corresponding to adjacent wells of the microplate 20.

When the same number of sets of the optical measurement sections, each of which consists of the light source 12a, the light receiving .light guide path 13a, and the light receiving sensor 12b, as the number of wells 21 are provided as shown in FIG. 1, and the like, the cost of the optical measurement sections increases as the number of wells in the microplate 20 increases. In addition, the greater the number of wells in the microplate 20, the narrower the pitch between adjacent wells 21 becomes, and the more difficult it becomes to align the optical measurement sections.

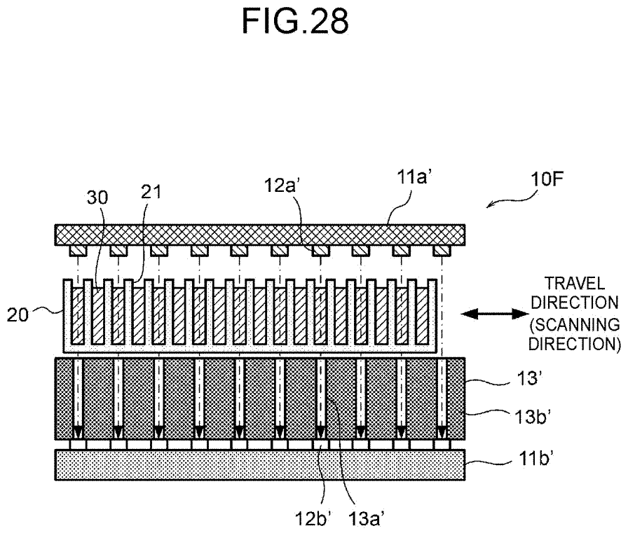

To cope with this, a set of the light source 12a′, the light receiving light guide path 13a′, and the light receiving sensor 12b′ may be arranged corresponding to every other well 21, as in the microplate reader 10F shown in FIG. 28.

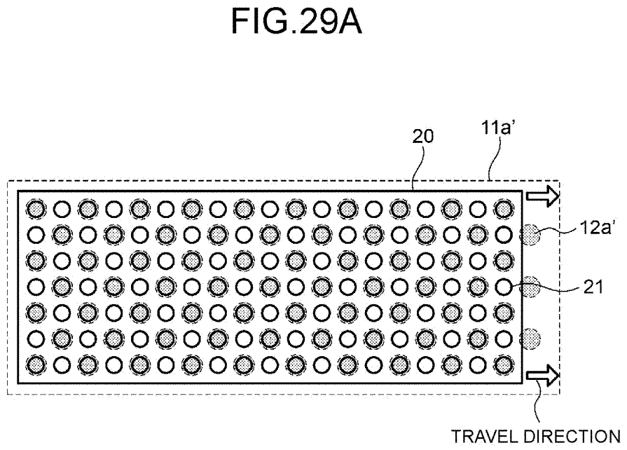

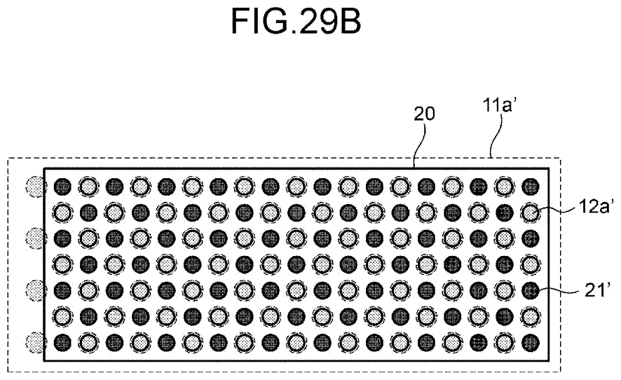

In the case of the microplate reader 10F, as shown in FIG. 29A, the sets of the light source 12a′, the light receiving light guide path 13a′, and the light receiving sensor 12b′ may be arranged in a checkered pattern with respect to the position of respective wells 21 of the microplate 20. In this case, by moving the microplate 20 by one row in the direction of the arrow in FIG. 29A, the optical measurement can be performed for all wells 21 of the microplate 20 as shown in FIG. 29B.

In other words, in the first optical measurement, as shown in FIG. 29A, the optical measurement is performed for the wells 21 to which the light sources 12a′ are arranged opposite, respectively, and subsequently in the second optical measurement, as shown in FIG. 29B, the optical measurement is performed for the wells 21 for which the optical measurement was not performed in the first optical measurement. In FIG. 29B, the black-filled wells 21′ are the wells where the optical measurement was performed in the first optical measurement.

The above described configuration can appropriately handle optical measurements of microplates with a large number of wells, for example, a 1536-well microplate with a pitch of 2.25 mm between wells 21.

In addition, since the microplate reader 10F only requires switching the position of the microplate 20 between two positions, complicated control such as a motor position control is not necessary, and the moving mechanism can be configured inexpensively with a simple actuator.

The above described microplate reader 10F can be used in an incubator, for example.

The incubator is provided with an incubator space (culture space) inside which culture vessels are housed. Generally, the incubator space has a plurality of shelves arranged horizontally and spaced apart in the vertical direction, and the culture vessels are placed on these shelves. Therefore, in order to increase the number of shelves, the microplate reader used in the incubator is required to be thin.

Also, in the incubator, it is desirable not to give external stimuli (e.g., vibrations) to the cells in the wells (e.g., stem cells) as much as possible.

As described above, since the microplate reader 10F moves only in one axis, it makes it possible to avoid the device configuration to be larger in the height direction. In addition, since the microplate reader 10F moves only between two positions, scanning can be kept to a minimum, with no vibration or other stimuli.

Therefore, the microplate reader 10F can be a microplate reader suitable for use in the incubator.

Although certain embodiments have been described above, such embodiments are merely illustrative and are not intended to limit the scope of the present invention. The apparatus and methods described herein can be embodied in forms other than those described above. Also, without departing from the scope of the present invention, omissions, substitutions, and modifications may be made to the above embodiments as appropriate. Such omitted, substituted, and modified forms are included in the scope of the claims and their equivalents and belong to the technical scope of the present invention.

### REFERENCE SIGNS LIST

10: Microplate Reader

11a: Light Emitting Substrate

11b: Measurement Substrate

12a: Light Source

13: Light Guide Plate Section

13a: Light Receiving Light Guide Path

15: Housing

18: Microplate Reader Unit

20: Microplate

21: Well

1. A microplate reader comprising:
a housing;
a light emitting portion disposed on one side of a microplate having a plurality of wells in the housing and configured to correspond to one well of the microplate;
a light receiving portion disposed on an opposite side to the light emitting portion across the microplate and configured to correspond to one well of the microplate;
a light receiving light guide path disposed between the light receiving portion and the microplate and configured to guide light emitted from the light emitting portion and passing through a sample contained in the well to the light receiving portion; and
a light guiding section configured to enclose a plurality of the light receiving light guide paths by an enclosure member made of a pigment-containing resin containing a pigment having a light-absorbing property, and
a plurality of sets of the light emitting portion, the light receiving portion, and the light receiving light guide path being provided corresponding to one well of the microplate, and
light emitted from one light emitting portion passing through one light receiving light guide path and reaching one light receiving portion.

2. The microplate reader according to claim 1, wherein
a number of sets of the light emitting portion, the light receiving portion, and the light receiving light guide path corresponding to one well is at least as many as a number of the wells in the microplate.

3. The microplate reader according to claim 1, wherein
a number of sets of the light emitting portion, the light receiving portion, and the light receiving light guide path corresponding to one well is less than a number of the wells, and
the microplate reader further comprises a moving mechanism configured to sequentially move the microplate relative to the set of the light emitting portion, the light receiving portion, and the light receiving light guide path so as to correspond to all wells of the microplate.

3. The microplate reader according to claim 3, wherein
a number of sets of the light emitting portion, the light receiving portion, and the light receiving light guide path corresponding to one well is as many as a number of wells on one side of the microplate, and
the moving mechanism sequentially moves the microplate relative to the set of the light emitting portion, the light receiving portion, and the light receiving light guide portion solely in a direction orthogonal to the one side.

5. The microplate reader according to claim 1, wherein
where o denotes a point where a light emitting surface on which light emitters of a plurality of the light emitting portions are disposed and an optical axis of the light receiving light guide path intersect, La denotes a distance from the light emitting surface to an end face of the light receiving light guide path on the light receiving portion side, Lab denotes an optical path length of the light receiving light guide path, and d denotes a width of the light receiving light guide path,
the light emitting portion is arranged such that only one light emitter of the light emitting portion lies in a circular region of a radius r defined by a following equation with the point o at a center on the light emitting surface:
r=d(La/Lb−1/2)

6. The microplate reader according to claim 1, further comprising:
a limiting member configured to limit light emitted from the light emitting portion adjacent to the one light emitting portion from entering the one light receiving light guide path corresponding to the one light emitting portion.

7. The microplate reader according to claim 6, wherein
the limiting member is an aperture plate disposed on the light emitting portion side of the light guiding section and configured to have an aperture allowing light passing through the sample to enter the light receiving light guide path and being smaller than an aperture of a light incident end of the light receiving light guide path.

8. The microplate reader according to claim 6, wherein
the limiting member is a protruding portion provided on an inner wall of the light receiving light guide path and configured to limit a width of the light receiving light guide path.

9. The microplate reader according to claim 6, wherein
the limiting member is a shielding member disposed between the light emitting portions adjacent to each other.

10. The microplate reader according to claim 1, wherein
the light guiding section is disposed above the light receiving portion, and the light emitting portion is disposed above the microplate disposed above the light guiding section.

11. The microplate reader according to claim 1, further comprising:
a light emitting substrate having a power supply circuit to supply power to the plurality of light emitting portions and to which the light emitting portions are electrically connected; and
a light receiving substrate having a power supply circuit to supply power to the plurality of light receiving portions and to which the light emitting portions are electrically connected.

12. The microplate reader according to claim 1, wherein
the light emitting portion is a light emitting diode (LED).

13. The microplate reader according to claim 1, wherein
the light receiving portion is a light receiving sensor.

14. The microplate reader according to claim 1, wherein
the light receiving portion is an optical fiber.

15. The microplate reader according to claim 1, wherein
at least a part of the light receiving light guide path is filled with a resin having a light transmitting property, which constitutes the pigment-containing resin.

16. The microplate reader according to claim 1, wherein
the light receiving light guide path is made of a resin having a light transmitting property and consists of a flat part and a columnar member extending from the flat part in a columnar shape.

17. The microplate reader according to claim 16, wherein
a stepped portion is provided at a connecting part between the flat part and the columnar member such that a diameter at the connecting part side is larger than a diameter at a front end of the columnar member.

18. A microplate reader unit comprising:
a unit light source section having a light emitting portion corresponding to one well of a microplate; and
a unit light guiding section including:
a light receiving portion provided corresponding to one well of the microplate;
a light receiving light guide path configured to guide light emitted from the light emitting portion and passing through a sample contained in a corresponding well to the light receiving portion; and
an enclosure member configured to enclose the light receiving light guide path by a pigment-containing resin containing a pigment having a light absorbing property, and light that passes through the light receiving light guide path included in one unit light guiding section and reaches the light receiving portion is light emitted from the light emitting portion included one unit light source section.

19. The microplate reader unit according to claim 18, wherein
the light receiving light guide path is made of a resin having a light transmitting property and consists of a flat part and a columnar member extending from the flat part in a columnar shape.

20. The microplate reader unit according to claim 19, wherein
a stepped portion is provided at a connecting part between the flat part and the columnar member such that a diameter at the connecting part side is larger than a diameter at a front end of the columnar member.
